(19) United States
(12) Patent Application Publication
(10) Pub. No.: US 2011/0279673 A1
(43) Pub. Date: Nov. 17, 2011

(54) MARITIME CONTROLS SYSTEMS AND METHODS

(75) Inventors: Andrew C. Teich, West Linn, OR (US); Allen Frechette, West Linn, OR (US); Jeffrey D. Frank, Santa Barbara, CA (US); James T. Woolaway, Santa Barbara, CA (US); Austin A. Richards, Santa Barbara, CA (US); Patrick B. Richardson, Santa Barbara, CA (US); Nicholas Högasten, Santa Barbara, CA (US)

(73) Assignee: FLIR SYSTEMS, INC., Wilsonville, OR (US)

(21) Appl. No.: 12/973,371

(22) Filed: Dec. 20, 2010

Related U.S. Application Data
(63) Continuation-in-part of application No. 11/946,801, filed on Nov. 28, 2007.

(51) Int. Cl. H04N 7/18; G09G 5/00

(52) U.S. Cl. 348/148; 345/661

(57) ABSTRACT

Systems and methods disclosed herein provide for various embodiments of maritime control components. For example in one embodiment, a control component, adapted to be used with a watercraft, includes a mounting feature adapted to mount the control component to a steering wheel of the watercraft, and a mode selector of the control component adapted to receive and transmit a first user input signal corresponding to a user selected mode of operation from a plurality of selectable modes of operation including a map mode, a sonar mode, a fishfinder mode, a radar mode, an autopilot pattern mode, an entertainment mode, and/or a maritime mode. The control component further includes an increase/decrease actuator adapted to receive and transmit a second user input signal corresponding to a user selection within the user selected mode of operation. Embodiments of a watercraft and a method of display control are also provided.

### CROSS-REFERENCE TO RELATED APPLICATIONS

This continuation-in-part patent application claims the benefit of and priority to U.S. patent application Ser. No. 11/946,801 filed Nov. 28, 2007, which is incorporated herein by reference in its entirety.

### TECHNICAL FIELD

The present disclosure relates to controls in imaging systems and, in particular, to a display control in imaging systems for maritime applications.

### BACKGROUND

Various imaging apparatuses and modes of operation may be utilized to capture images in maritime applications, such as for display on a multifunction display. As an example, infrared cameras are utilized in a variety of imaging applications to capture infrared images and may be utilized for maritime applications to enhance visibility under various conditions for a maritime crew. However, there generally are a number of drawbacks for conventional maritime implementation approaches for infrared cameras.

One drawback of conventional systems is that a user is generally not allowed to switch between different processing techniques during viewing of the infrared image or the optimal settings may be difficult to determine by the user. Another drawback is that user-controlled processing may occur post capture, after initial processing has been performed, which generally lessens the user's input and control and may result in a less than desirable image being displayed. Furthermore, a drawback of conventional multifunction displays has been the difficulty in easily switching between different views or modes of operation, or adjusting the display output in a particular mode of operation while a user's hands are occupied, such as with tasks associated with controlling the watercraft.

As a result, there is a need for an improved apparatus and techniques for providing simple selectable viewing controls for a display (e.g., coupled to an imaging apparatus). There is also a need for improved processing techniques for maritime applications.

### BRIEF SUMMARY

Systems, apparatuses, and methods disclosed herein, in accordance with one or more embodiments, provide a control component, a watercraft, and a method for display control, such as for maritime applications. For example in accordance with one embodiment, a control component, adapted to be used with a watercraft, includes a mounting feature adapted to mount the control component to a steering wheel of the watercraft, and a mode selector of the control component adapted to receive and transmit a first user input signal corresponding to a user selected mode of operation from a plurality of selectable modes of operation including a map mode, a sonar mode, a fishfinder mode, a radar mode, an autopilot pattern mode, an entertainment mode, and/or a maritime mode. The control component further includes an increase/decrease actuator of the control component adapted to receive and transmit a second user input signal corresponding to a user selection within the user selected mode of operation.

In accordance with another embodiment of the present disclosure, a watercraft comprises at least one image capture component coupled to the watercraft to capture images (e.g., around the watercraft), a memory component adapted to store the captured images, a processing component adapted to process the captured images according to a plurality of modes of operation to provide processed images, a display component adapted to display the processed images, and a control component mounted to a steering wheel of the watercraft.

In accordance with yet another embodiment of the present disclosure, a method includes receiving a first user input signal corresponding to a user selected mode of operation from a plurality of selectable modes of operation including a map mode, a sonar mode, a fishfinder mode, a radar mode, an autopilot pattern mode, an entertainment mode, and/or a maritime mode. The method further includes transmitting the first user input signal to a processing component to control a display component in accordance with the first user input signal, receiving a second user input signal corresponding to an increase or decrease selection within the user selected mode of operation, and transmitting the second user input signal to the processing component to control the display component in accordance with the second user input signal.

The scope of the disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIGS. 1A-1B show block diagrams illustrating various imaging systems for capturing and processing images (e.g., infrared) in accordance with various embodiments of the present disclosure.

FIGS. 1C-1D show block diagrams illustrating various configurations for the imaging systems in accordance with various embodiments of the present disclosure.

FIGS. 1E-1F show block diagrams illustrating various views of the imaging systems in accordance with various embodiments of the present disclosure.

FIG. 2 shows a block diagram illustrating a method for capturing and processing images in accordance with an embodiment of the present disclosure.

FIGS. 3A-3F show block diagrams illustrating infrared processing techniques in accordance with various embodiments of the present disclosure.

FIG. 4 shows a block diagram illustrating an overview of infrared processing techniques in accordance with various embodiments of the present disclosure.

FIG. 5 shows a block diagram illustrating a control component of the infrared imaging system for selecting between different modes of operation in accordance with an embodiment of the present disclosure.

FIG. 6 shows a block diagram illustrating an embodiment of an image capture component of imaging systems in accordance with an embodiment of the present disclosure.

FIG. 7 shows a block diagram illustrating an embodiment of a method for monitoring image data of the infrared imaging systems in accordance with an embodiment of the present disclosure.

FIGS. 8A and 8B show block diagrams illustrating embodiments of a control component of an imaging system for selecting between different modes of operation and/or display in accordance with embodiments of the present disclosure.

FIGS. 9A and 9B illustrate a system including a control component, a maritime steering wheel, and a multifunction display in accordance with embodiments of the present disclosure.

FIGS. 10A and 10B illustrate different views of the control component illustrated in FIGS. 9A and 9B in accordance with embodiments of the present disclosure.

FIG. 11 illustrates another control component for selecting between different modes of operation and/or display in accordance with another embodiment of the present disclosure.

FIG. 12 shows a block diagram illustrating a method for display control in accordance with an embodiment of the present disclosure.

FIG. 13 shows a block diagram illustrating an overview of first and second user input selections for display control in accordance with various embodiments of the present disclosure.

FIGS. 14A and 14B illustrate another control component for selecting between different modes of operation and/or display in accordance with another embodiment of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

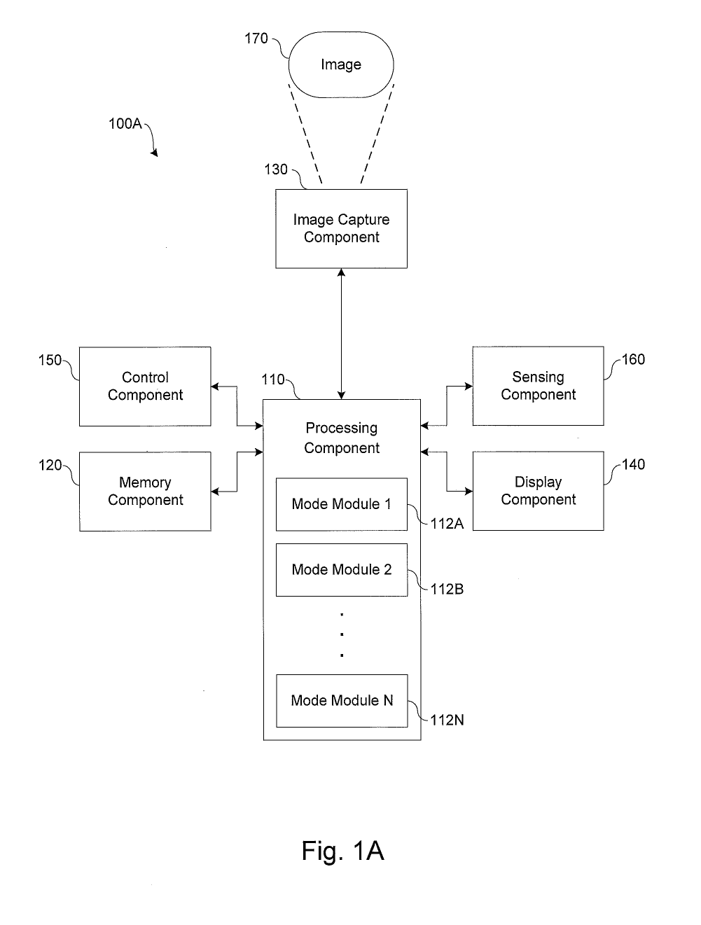

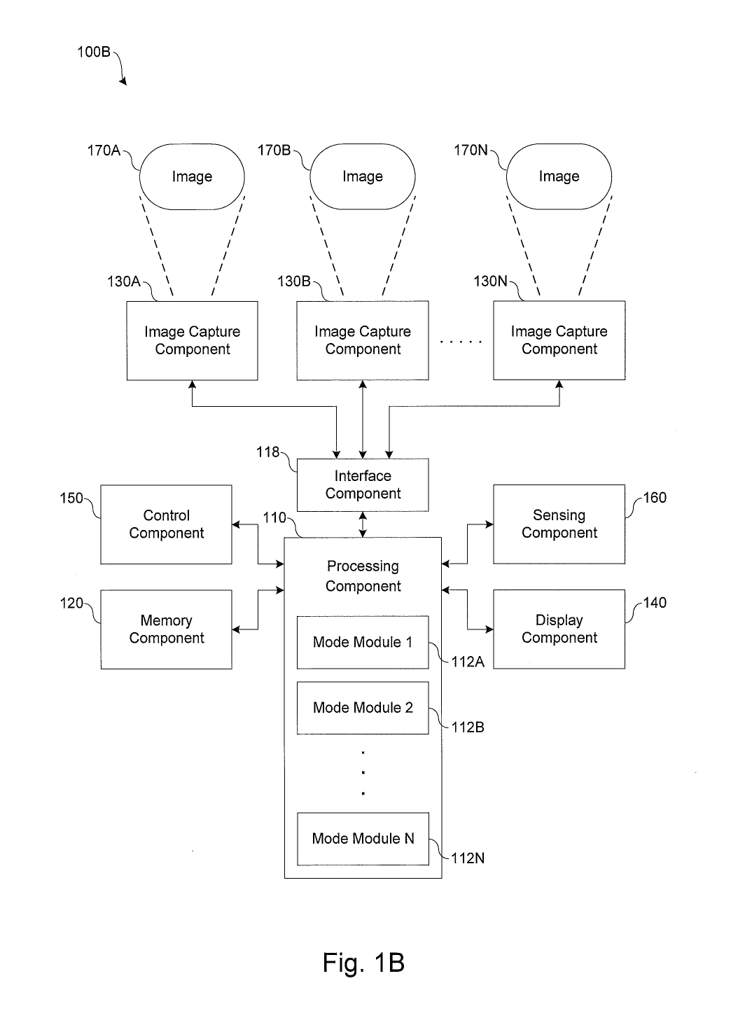

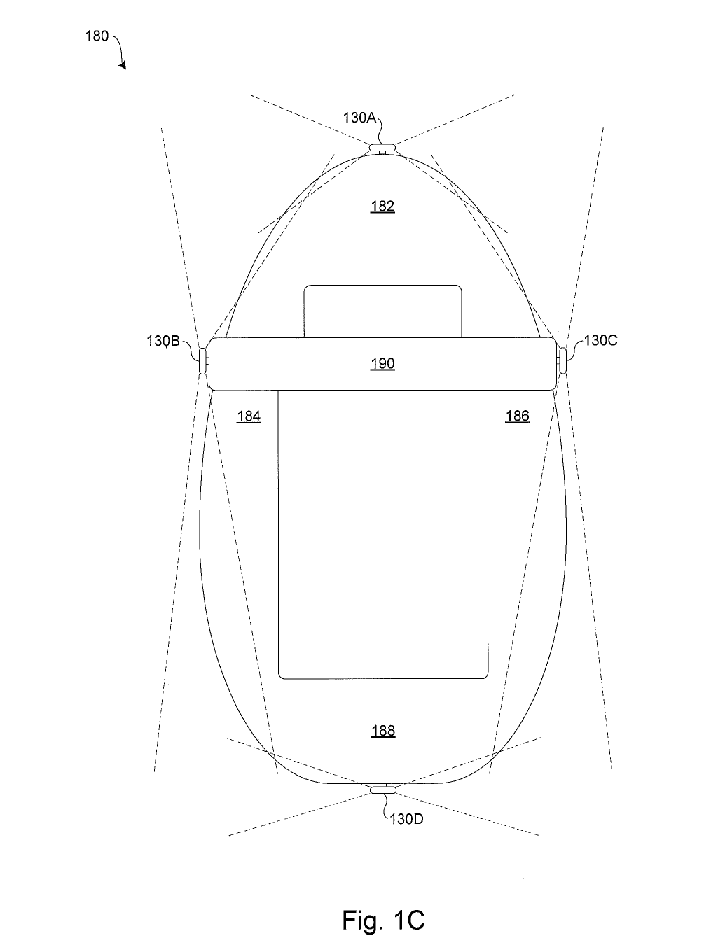

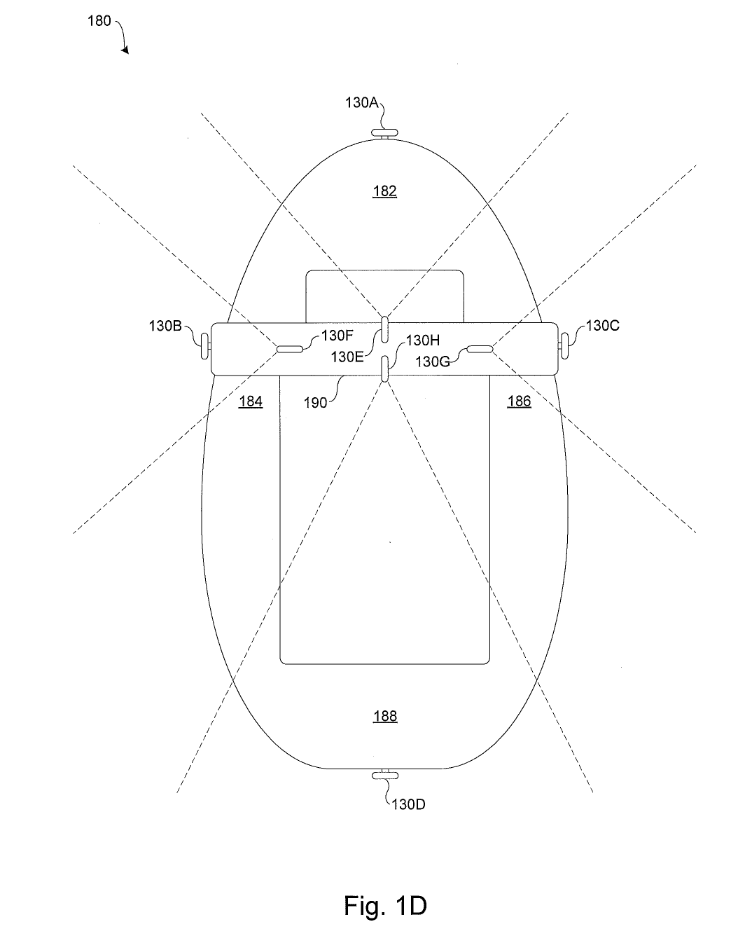

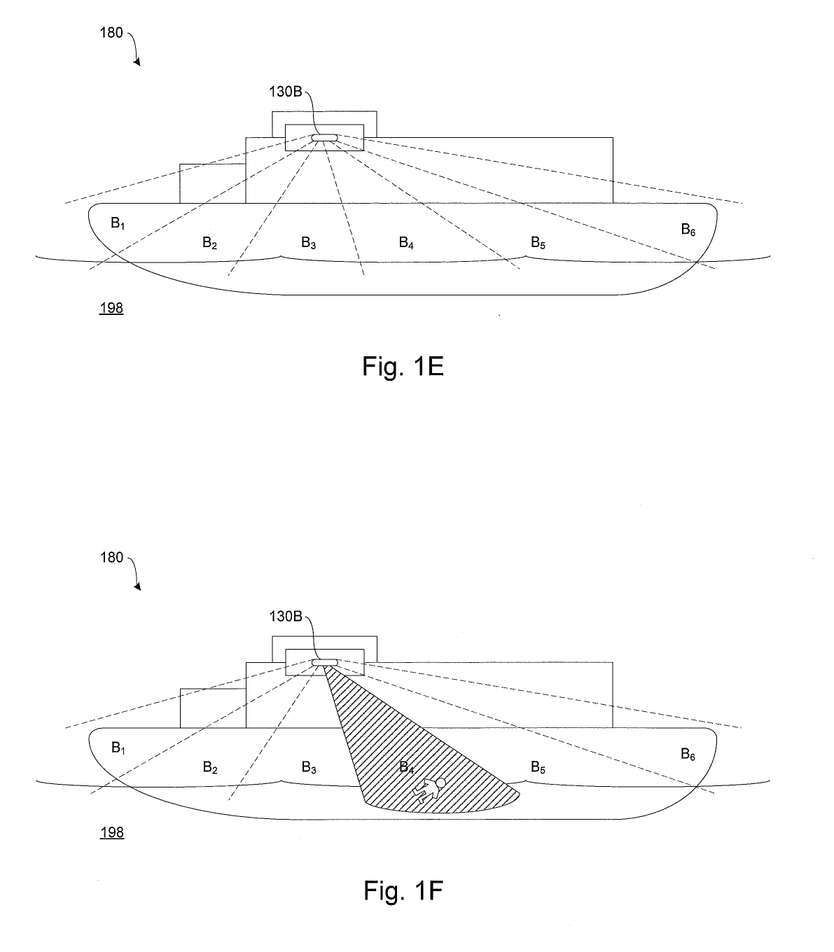

In accordance with an embodiment of the present disclosure, FIG. 1A shows a block diagram illustrating an imaging system 100A for capturing and processing images, e.g., by infrared, radar, and/or sonar. Imaging system 100A comprises a processing component 110, a memory component 120, an image capture component 130, a display component 140, a control component 150, and optionally a sensing component 160.

In various implementations, imaging system 100A may represent an infrared imaging device, such as an infrared camera, to capture images, such as an image 170 (e.g., of an object or scene). Imaging system 100A may represent any type of infrared camera, which for example detects infrared radiation and provides representative data (e.g., one or more snapshots or video infrared images). For example, imaging system 100A may represent an infrared camera that is directed to the near, middle, and/or far infrared spectrums. Imaging system 100A may comprise a portable device and may be incorporated, for example, into any type of vehicle (e.g., a watercraft, a land-based vehicle, an aircraft, or a spacecraft) or a non-mobile installation requiring infrared images to be stored and/or displayed. In other implementations, imaging system 100A may represent a radar imaging device and/or a sonar imaging device to capture images, such as image 170, and control component 150 and display component 140 may be housed as individual components configured to be in communication with one another and/or the other system components, as will be described in greater detail herein. In yet other implementations, imaging system 100A may represent an imaging device using other or various parts of the electromagnetic and/or acoustic spectrum.

Processing component 110 comprises, in one embodiment, a microprocessor, a single-core processor, a multi-core processor, a microcontroller, a logic device (e.g., a programmable logic device configured to perform processing functions), a digital signal processing (DSP) device, or some other type of generally known processor. Processing component 110 is adapted to interface and communicate with components 120, 130, 140, 150 and 160 to perform method and processing steps as described herein. Processing component 110 may comprise one or more mode modules 112A-112N for operating in one or more modes of operation, which is described in greater detail herein. In one implementation, mode modules 112A-112N define functions (e.g., preset display functions) that may be embedded in processing component 110 or stored on memory component 120 for access and execution by processing component 110. Moreover, processing component 110 may be adapted to perform various other operations (e.g., various types of image processing algorithms) in a manner as described herein.

In various implementations, it should be appreciated that each of mode modules 112A-112N may be integrated in software and/or hardware as part of processing component 110, or code (e.g., software or configuration data) for each of the modes of operation associated with each mode module 112A-112N, which may be stored in memory component 120. Embodiments of mode modules 112A-112N (i.e., modes of operation) disclosed herein may be stored by a separate computer-readable medium (e.g., a memory, such as a hard drive, a compact disk, a digital video disk, or a flash memory) to be executed by a computer (e.g., a logic or processor-based system) to perform various methods disclosed herein. In one example, the computer-readable medium may be portable and/or located separate from imaging system 100A, with stored mode modules 112A-112N provided to imaging system 100A by coupling the computer-readable medium to imaging system 100A and/or by imaging system 100A downloading (e.g., via a wired or wireless link) the mode modules 112A-112N from the computer-readable medium (e.g., as represented by memory component 120 for one or more embodiments). As described in greater detail herein, in one embodiment mode modules 112A-112N provide for improved infrared camera processing techniques for real time applications, wherein a user or operator may change the mode while viewing an image on display component 140. In other embodiments, mode modules 112A-112N provide for processing techniques for different real time imaging applications when using radar, sonar, or other sensing techniques, for example.

Memory component 120 comprises, in one embodiment, one or more memory devices to store data and information. The one or more memory devices may comprise various types of memory including volatile and non-volatile memory devices, such as RAM (Random Access Memory), ROM (Read-Only Memory), EEPROM (Electrically-Erasable Read-Only Memory), flash memory, etc. Processing component 110 is adapted to execute software stored in memory component 120 to perform methods, processes, and/or modes of operations in the manner as described herein.

Image capture component 130 comprises, in one embodiment, one or more infrared sensors (e.g., any type of infrared detector, such as a focal plane array) for capturing infrared image signals representative of an image, such as image 170. In other embodiments, image capture component 130 comprises one or more visible light, radar, and/or sonar sensors for capturing image signals representative of an image, such as image 170. For example for the visible light camera, any type of visible light camera may be used, including low-light visible cameras (e.g., electron-multiplying charge-coupled device (EMCCD)-based cameras). In yet other embodiments, image capture component 130 comprises one or more electromagnetic or acoustic spectrum sensors for capturing image signals.

In one implementation, the sensors of image capture component 130 provide for representing (e.g., converting) a captured image signal of image 170 as digital data (e.g., via an analog-to-digital converter included as part of the sensor or separate from the sensor as part of imaging system 100A). Processing component 110 may be adapted to receive the image signals from image capture component 130, process the image signals (e.g., to provide processed image data), store the image signals or image data in memory component 120, and/or retrieve stored image signals from memory component 120. Processing component 110 may be adapted to process infrared, radar, sonar, and/or other electromagnetic/acoustic spectrum image signals stored in memory component 120 to provide image data (e.g., captured and/or processed image data) to display component 140 for viewing by a user.

Display component 140 comprises, in one embodiment, an image display device (e.g., a liquid crystal display (LCD)) or various other types of generally known video displays or monitors. Processing component 110 may be adapted to display image data and information on display component 140. Processing component 110 may also be adapted to retrieve image data and information from memory component 120 and display any retrieved image data and information on display component 140. Display component 140 may comprise display electronics, which may be utilized by processing component 110 to display image data and information (e.g., infrared, radar, and/or sonar images). Display component 140 may receive image data and information directly from image capture component 130 via processing component 110, or the image data and information may be transferred from memory component 120 via processing component 110. In one implementation, processing component 110 may initially process a captured image and present a processed image in one mode, corresponding to mode modules 112A-112N, and then upon user input to control component 150, processing component 110 may switch the current mode to a different mode for viewing the processed image on display component 140 in the different mode. This switching may be referred to as applying the infrared camera, radar, sonar, or other sensing processing techniques of mode modules 112A-112N for real time applications, wherein a user or operator may change the mode while viewing an image on display component 140 based on user input to control component 150.

Control component 150 comprises, in one embodiment, a user input and/or interface device having one or more user actuated components (e.g., selectors), such as one or more push buttons, flippers, toggle switches, slide bars, rotatable knobs, and/or a keyboard, that are adapted to generate one or more user actuated input control signals. Note that it should be understood from the disclosure herein that the term “button” and the term “actuator” may refer to any type of user-input actuated selector component. Control component 150 may be adapted to be integrated as part of display component 140 to function as both a user input device and a display device, such as, for example, a touch screen device adapted to receive input signals from a user touching different parts of the display screen. Processing component 110 may be adapted to sense control input signals from control component 150 and respond to any sensed control input signals received therefrom. Processing component 110 may be adapted to interpret the control input signal as a value, which will be described in greater detail herein.

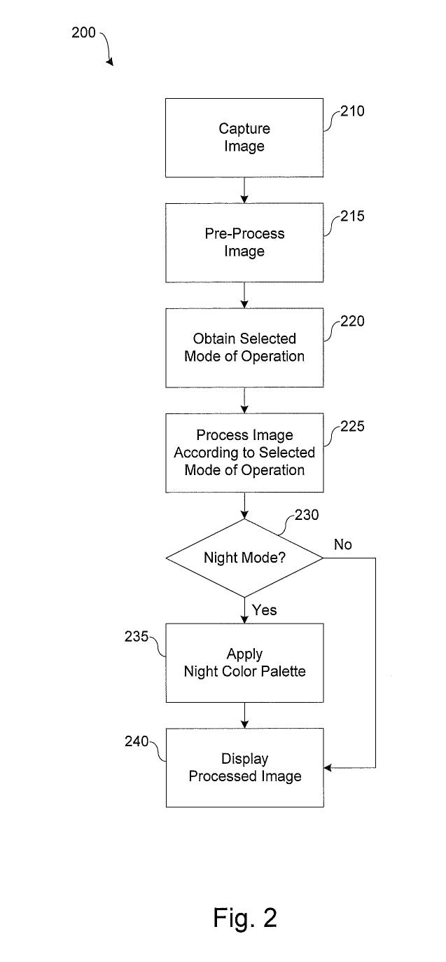

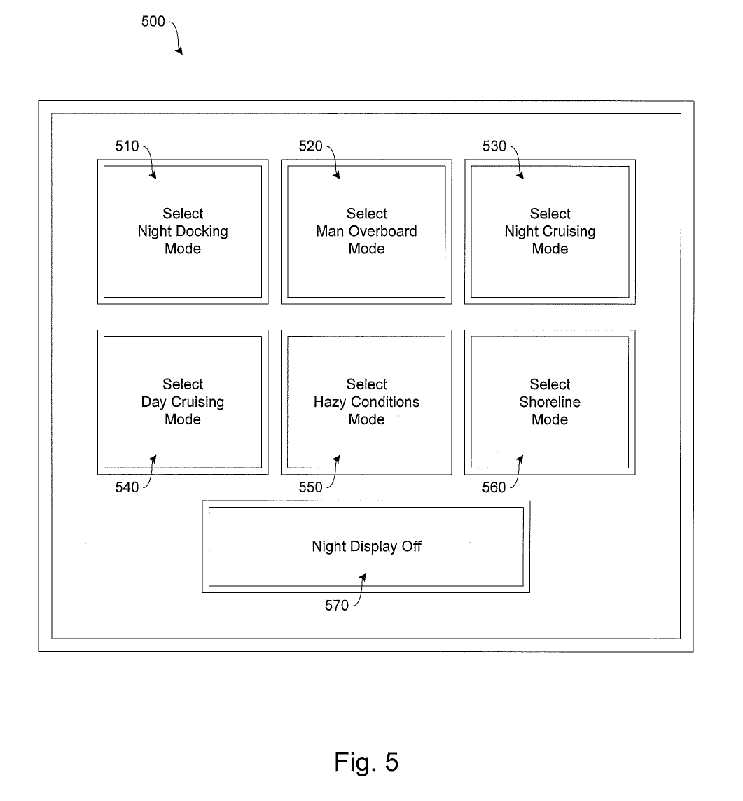

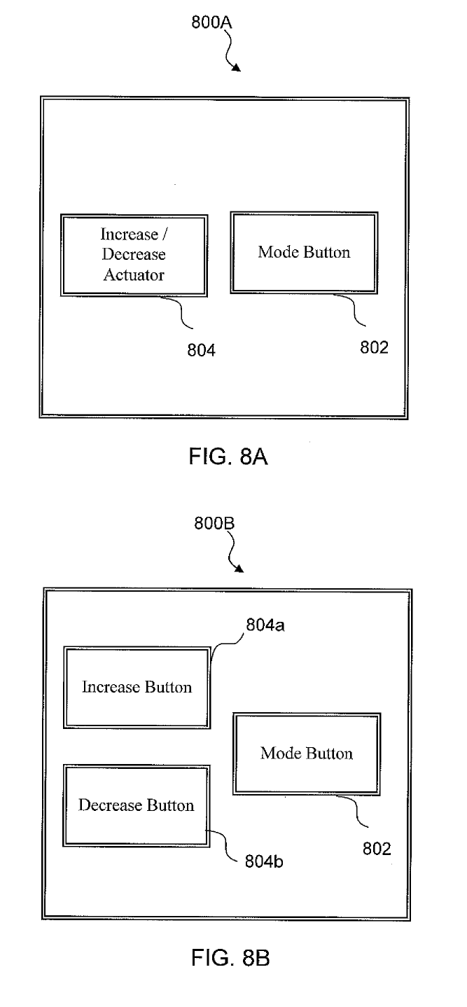

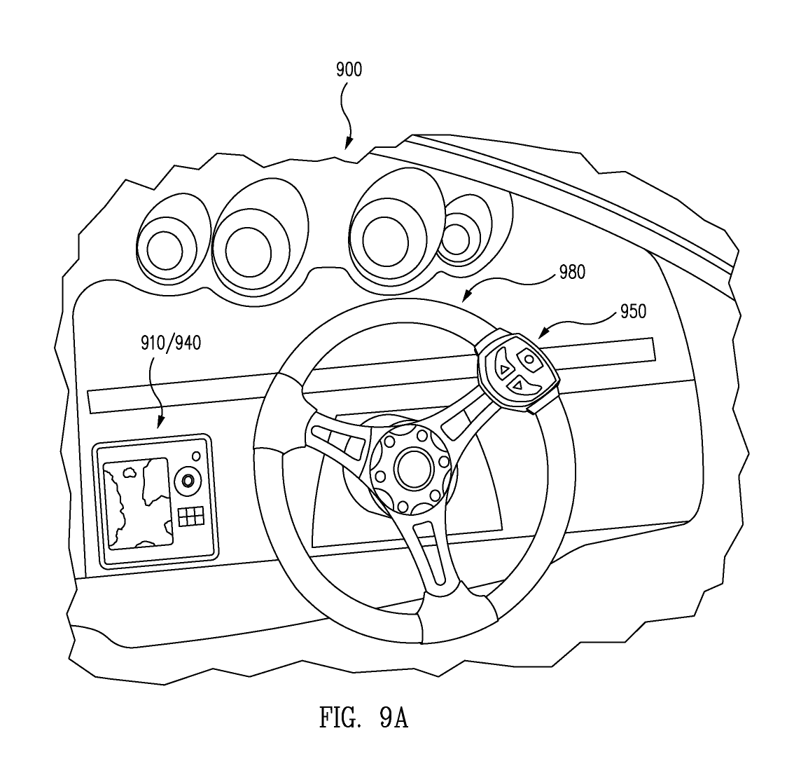

Control component 150 may comprise, in one embodiment, a control panel unit (e.g., a wired or wireless handheld or steering wheel mounted control unit) having one or more push buttons (e.g., selectors) adapted to interface with a user and receive user input control values, as shown in different embodiments in FIG. 5 (control panel unit 500) and FIGS. 8A-11 and 14A-14B (e.g., steering wheel control components 800A, 800B, 950, 1150, and 1450) and further described herein. In various implementations, one or more push buttons of a control panel unit may be utilized to select between the various modes of operation as described herein in reference to FIGS. 2-4 and 12-13. For example, only one push button may be implemented and which is used by the operator to cycle through the various modes of operation (e.g., map mode, sonar mode, fishfinder mode, autopilot mode, radar mode, entertainment mode, maritime mode), with the selected mode indicated on the display component 140. In various other implementations, it should be appreciated that a control panel unit may be adapted to include one or more other push buttons to provide various other control functions of imaging system 100A, such as auto-focus, menu enable and selection, field of view (FOV), brightness, contrast, gain, offset, spatial, temporal, zoom, sensitivity, autopilot pattern, range, volume, disc tracks, maritime mode of image processing, and/or various other features and/or parameters. In another implementation, a variable gain value may be adjusted by the user or operator based on a selected mode of operation.

In another embodiment, control component 150 may comprise a graphical user interface (GUI), which may be integrated as part of display component 140 (e.g., a user actuated touch screen), having one or more images of, for example, push buttons adapted to interface with a user and receive user input control values.

Optional sensing component 160 comprises, in one embodiment, one or more various types of sensors, including environmental sensors, depending upon the desired application or implementation requirements, which provide information to processing component 110. Processing component 110 may be adapted to communicate with sensing component 160 (e.g., by receiving sensor information from sensing component 160) and with image capture component 130 (e.g., by receiving data from image capture component 130 and providing and/or receiving command, control or other information to and/or from other components of imaging system 100A).

In various implementations, optional sensing component 160 may provide data and information relating to environmental conditions, such as outside temperature, lighting conditions (e.g., day, night, dusk, and/or dawn), humidity level, specific weather conditions (e.g., sun, rain, and/or snow), distance (e.g., laser rangefinder), and/or whether a tunnel, a covered dock, or that some type of enclosure has been entered or exited. Optional sensing component 160 may represent conventional sensors as would be known by one skilled in the art for monitoring various conditions (e.g., environmental conditions) that may have an affect (e.g., on the image appearance) on the data provided by image capture component 130.

In some embodiments, optional sensing component 160 (e.g., one or more of sensors) may comprise devices that relay information to processing component 110 via wireless communication. For example, sensing component 160 may be adapted to receive information from a satellite, through a local broadcast (e.g., radio frequency) transmission, through a mobile or cellular network and/or through information beacons in an infrastructure (e.g., a transportation or highway information beacon infrastructure) or various other wired or wireless techniques.

In various embodiments, components of imaging system 100A may be combined and/or implemented or not, as desired or depending upon the application or requirements, with imaging system 100A representing various functional blocks of a system. For example, processing component 110 may be combined with memory component 120, image capture component 130, display component 140, control component, and/or sensing component 160. In another example, processing component 110 may be combined with image capture component 130 with only certain functions of processing component 110 performed by circuitry (e.g., a processor, a microprocessor, a microcontroller, a logic device, etc.) within image capture component 130. In a further example, components of imaging system 100A may be distributed within a networked or linked system. In still another example, control component 150 may be combined with one or more other components or may be remotely connected to at least one other component, such as processing component 110 and/or display component 140, via a control wire or wireless connection so as to provide control signals thereto. For example, control component 150 may include a transmitter and/or a transceiver to wirelessly communicate with other portions of imaging system 100A.

In accordance with another embodiment of the present disclosure, FIG. 1B shows a block diagram illustrating an imaging system 100B for capturing and processing images, e.g., infrared, sonar, radar, or other electromagnetic/acoustic spectrum images. Imaging system 10013 comprises, in one embodiment, processing component 110, an interface component 118, memory component 120, one or more image capture components 130A-130N, display component 140, control component 150, and optionally sensing component 160. It should be appreciated that various components of imaging system 100B of FIG. 1B may be similar in function and scope to components of imaging system 100A of FIG. 1A, and differences between the systems 100A, 100B are described in greater detail herein.

In various implementations, imaging system 100B may represent one or more imaging devices, such as one or more infrared cameras, to capture images, such as images 170A-170N. In general, imaging system 100B may utilize a plurality of infrared cameras, which for example detect infrared radiation and provide representative data (e.g., one or more snapshots or video infrared images). For example, imaging system 100B may include one or more infrared cameras that are directed to the near, middle, and/or far infrared spectrums. As discussed further herein, imaging system 100B may be incorporated, for example, into a vehicle (e.g., a watercraft (water-based vehicle), a land-based vehicle, an aircraft, or a spacecraft) or a non-mobile installation requiring infrared images to be stored and/or displayed. In other implementations, imaging system 100B may represent a radar imaging device and/or a sonar imaging device to capture images, and control component 150 and display component 140 may be housed as individual components configured to be in communication with one another and/or the other system components, as will be described in greater detail herein. In yet other implementations, imaging system 100B may represent an imaging device using other or various parts of the electromagnetic and/or acoustic spectrum.

Processing component 110 is adapted to interface and communicate with a plurality of components including components 118, 120, 130A-130N, 140, 150, and/or 160 of system 100B to perform method and processing steps as described herein. Processing component 110 may comprise one or more mode modules 112A-112N for operating in one or more modes of operation, which is described in greater detail herein. Processing component 110 may be adapted to perform various other types of image processing algorithms in a manner as described herein.

Interface component 118 comprises, in one embodiment, a communication device (e.g., modem, router, switch, hub, or Ethernet card) that allows communication between each image capture component 130A-130N and processing component 110. As such, processing component 110 is adapted to receive image signals (e.g., infrared, radar, sonar, etc.) from each image capture component 130A-130N via interface component 118.

Each image capture component 130A-130N (where “N” represents any desired number) comprises, in various embodiments, one or more infrared, radar, sonar, or other electromagnetic/acoustic sensors (e.g., any type of infrared detector, such as a focal plane array, or any type of radar or sonar sensor/scanner) for capturing image signals representative of an image, such as one or more images 170A-170N. In one implementation, the sensors of image capture component 130A provide for representing (e.g., converting) a captured image signal of, for example, image 170A as digital data (e.g., via an analog-to-digital converter included as part of the sensor or separate from the sensor as part of imaging system 100B). As such, processing component 110 may be adapted to receive the image signals from each image capture component 130A-130N via interface component 118, process the image signals (e.g., to provide processed image data or the processed image data may be provided by each image capture component 130A-130N), store the image signals or image data in memory component 120, and/or retrieve stored image signals from memory component 120. Processing component 110 may be adapted to process image signals stored in memory component 120 to provide image data (e.g., captured and/or processed image data) to display component 140 (e.g., one or more displays) for viewing by a user.

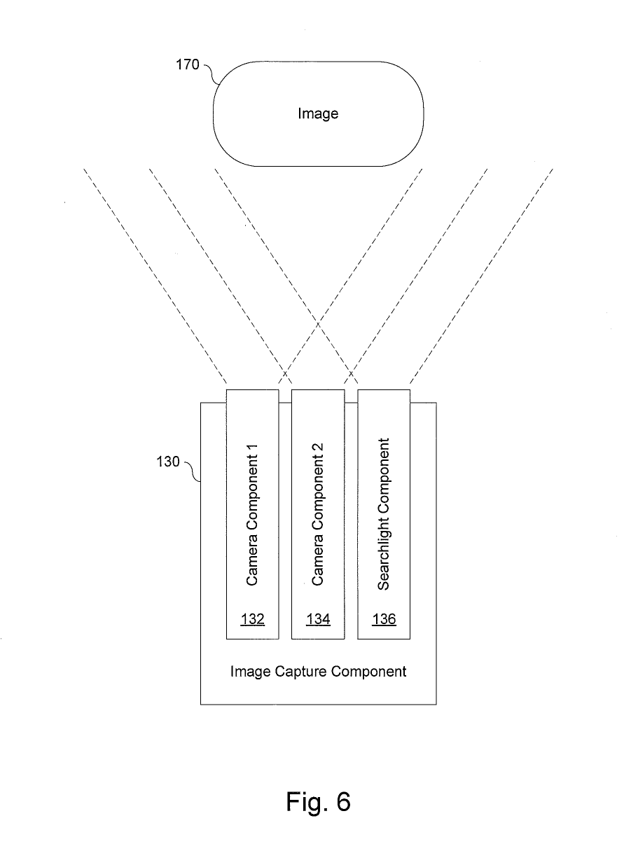

In one implementation as an example, referring briefly to FIG. 6, each image capture component 130A-130N may comprise one or more components, including a first camera component 132, a second camera component 134, and/or a searchlight component 136. In one embodiment as shown in FIG. 6, first camera component 132 is adapted to capture infrared images in a manner as described herein, second camera component 134 is adapted to capture color images in a visible light spectrum, and searchlight component 136 is adapted to provide a beam of light to a position within an image boundary of the one or more images 170 (e.g., within a field of view of first camera component 132 and/or second camera component 134). Further scope and function related to each of these components is described in greater detail herein.

FIG. 1C shows a top-view of imaging system 100B having a plurality of image capture components 130A-130D (e.g., infrared cameras, radar sensors, or sonar sensors) mounted to a watercraft 180 in accordance with an embodiment of the present disclosure. In various implementations, image capture components 130A-130D may comprise any type of infrared camera (e.g., infrared detector device) adapted to capture one or more infrared images, any type of radar sensor adapted to capture one or more radar images, and/or any type of sonar sensor adapted to capture one or more sonar images. Watercraft 180 may represent any type of watercraft (e.g., a boat, yacht, ship, cruise ship, tanker, commercial vessel, military vessel, etc.).

As shown in FIG. 1C, a plurality of image capture components 130A-130D may be mounted in a configuration at different positions on watercraft 180 in a manner so as to provide one or more fields of view around watercraft 180. In various implementations, an image capture component 130A may be mounted to provide a field of view ahead of or around a bow 182 (e.g., forward or fore part) of watercraft 180. As further shown, an image capture component 130B may be mounted to provide a field of view to the side of or around a port 184 (e.g., left side when facing forward towards bow 182) of watercraft 180. As further shown, an image capture component 130C may be mounted to provide a field of view to the side of or around a starboard 186 (e.g., right side when facing forward towards bow 182) of watercraft 180. As further shown, an image capture component 130D may be mounted to provide a field of view behind of or around a stern 188 (e.g., rear or aft part) of watercraft 180.

Thus, in one implementation, a plurality of image capture components 130A-130D may be mounted around the perimeter of watercraft 180 to provide fields of view thereabout. As an example and as discussed further herein, watercraft 180 may incorporate imaging system 100B to provide man overboard detection, to assist during various maritime modes of operation, such as night docking, night cruising, and/or day cruising of watercraft 180, and/or to provide various information, such as improved image clarity during hazy conditions or to provide a visual indication of the horizon and/or shoreline.

FIG. 1D shows a top-view of imaging system 100B having a plurality of image capture components 130E-130H (e.g., infrared cameras) mounted to a control tower 190 (e.g., bridge) of watercraft 180 in accordance with an embodiment of the present disclosure. As shown in FIG. 1D, a plurality of image capture components 130E-130H may be mounted to control tower 190 in a configuration at different positions on watercraft 180 in a manner so as to provide one or more fields of view around watercraft 180. In various implementations, image capture component 130E may be mounted to provide a field of view of bow 182 of watercraft 180. As further shown, image capture component 130F may be mounted to provide a field of view of port 184 of watercraft 180. As further shown, image capture component 130G may be mounted to provide a field of view of starboard 186 of watercraft 180. As further shown, image capture component 130H may be mounted to provide a field of view of stern 188 of watercraft 180. Thus, in one implementation, a plurality of image capture components 130E-130H may be mounted around control tower 190 of watercraft 180 to provide fields of view thereabout. Furthermore as shown, image capture components 130B and 130C may also be mounted on control tower 190 of watercraft 180.

FIG. 1E shows the port-side-view of imaging system 100B having port-side image capture component 130B of FIG. 1B mounted to watercraft 180 in accordance with an embodiment of the present disclosure. In reference to FIG. 1E, image capture component 130B provides a port-side field of view around watercraft 180.

In one implementation, image capture component 130B may provide a field of view of a port-side image of watercraft 180. In another implementation, the port-side field of view may be segmented into a plurality of views B₁-B₆. For example, image capture component 130B may be adapted to provide one or more segmented narrow fields of view of the port-side field of view including one or more forward port-side views B₁-B₃ and one or more rearward port-side views B₄-B₆. In still another implementation, as shown in FIG. 6, image capture component 130B may comprise a plurality of image capture components 132 (and optionally a plurality of image capture components 134) to provide the plurality of segmented or narrowed fields of view B₁-B₆ within the overall port-side field of view of watercraft 180.

As further shown in FIG. 1E, the port-side fields of view B₁-B₆ of watercraft 180 may extend through a viewing range from image capture component 130B to a water surface 198 adjacent to watercraft 180. However, in various implementations, the viewing range may include a portion below the water surface 198 depending on the type of infrared detector utilized (e.g., type of infrared camera, desired wavelength or portion of the infrared spectrum, and other relevant factors as would be understood by one skilled in the art).

FIG. 1F shows an example of locating and identifying a man overboard within the port-side field of view of port-side image capture component 130B mounted to watercraft 180 in accordance with an embodiment of the present disclosure. In one embodiment, image capture component 130B may be used to identify and locate a man overboard (e.g., within the narrowed port-side field of view B₃) of watercraft 180. Once the man overboard is identified and located, processing component 110 of imaging system 100B may control or provide information (e.g., slew-to-queue) to position searchlight component 136 within the port-side field of view B₃ to aid in visual identification and rescue of the man overboard. It should be understood that searchlight component 136 may be separate from image capture component 130B (e.g., separate housing and/or control) or may be formed as part of image capture component 130B (e.g., within the same housing or enclosure). Further scope and function related to this procedure is described in greater detail herein.

FIG. 2 shows a method 200 for capturing and processing images in accordance with an embodiment of the present disclosure. For purposes of simplifying discussion of FIG. 2, reference may be made to imaging systems 100A, 100B of FIGS. 1A, 1B as an example of a system, device or apparatus that may perform method 200.

Referring to FIG. 2, an image (e.g., infrared, radar, or sonar image signal) is captured (block 210) with imaging system 100A, 100B. In one implementation, processing component 110 induces (e.g., causes) image capture component 130 to capture an image, such as, for example, image 170. After receiving the captured image from image capture component 130, processing component 110 may optionally store the captured image in memory component 120 for processing.

Next, the captured image may optionally be pre-processed (block 215). In one implementation, pre-processing may include obtaining infrared, radar, and/or sonar sensor data related to the captured image, applying correction terms, and/or applying temporal noise reduction to improve image quality prior to further processing. In another implementation, processing component 110 may directly pre-process the captured image or optionally retrieve the captured image stored in memory component 120 and then pre-process the image. Pre-processed images may be optionally stored in memory component 120 for further processing.

Next, a selected mode of operation may be obtained (block 220). In one implementation, the selected mode of operation may comprise a user input control signal that may be obtained or received from control component 150 (e.g., control panel unit 500 of FIG. 5 or steering wheel control components 800A, 800B, 950, 1150, and 1450 in FIGS. 8A, 8B, 9A-10B, 11, and 14A-B). In various implementations, the mode of operation may be selected from at least one of map mode, sonar mode, fishfinder mode, autopilot pattern mode, radar mode, entertainment mode, and/or maritime mode, and the selected maritime mode of operation may be selected from at least one of night docking, man overboard, night cruising, day cruising, hazy conditions, and/or shoreline mode. As such, processing component 110 may communicate with control component 150 to obtain the selected mode of operation and/or display adjustments as inputs by a user. These modes of operation are described in greater detail herein and may include the use of one or more image processing algorithms and may use wired or wireless communications.

In one or more implementations, modes of operation may include and refer to preset processing and display functions for an image, and in one example, infrared imagers and infrared cameras are adapted to process infrared sensor data prior to displaying the data to a user. In other examples, other types of transceivers utilizing radar, sonar, or other electromagnetic/acoustic spectrum may be adapted to process sensor data prior to displaying the data to a user. In general, display algorithms attempt to present the scene (i.e., field of view) information in an effective way to the user. In some cases, infrared image processing algorithms are utilized to present a good image under a variety of conditions, and the infrared image processing algorithms provide the user with one or more options to tune parameters and run the camera in “manual mode” (e.g., user-selectable modes). In one aspect, imaging system 100A, 100B may be simplified by hiding advanced manual settings. In another aspect, the concept of preset image processing for different conditions may be implemented in maritime applications.

Next, referring to FIG. 2, the image is processed in accordance with the selected mode of operation (block 225), such as a map mode, a sonar mode, a fishfinder mode, an autopilot pattern mode, a radar mode, an entertainment mode, and a maritime mode, in a manner as described in greater detail herein. In one implementation, processing component 110 may store the processed image in memory component 120 for displaying. In another implementation, processing component 110 may retrieve the processed image stored in memory component 120 and display the processed image on display component 150 for viewing by a user.

Next, a determination is made as to whether to display the processed image in a night mode (block 230), in a manner as described in greater detail herein. If yes, then processing component 110 configures display component 140 to apply a night color palette to the processed image (block 235), and the processed image is displayed in night mode (block 240). For example, in night mode (e.g., for night docking, night cruising, or other modes when operating at night), an image may be displayed in a red palette or green palette to improve night vision capacity for a user. Otherwise, if night mode is not necessary, then the processed image is displayed in a non-night mode manner (e.g., black hot or white hot palette) (block 240).

In various implementations, the night mode of displaying images refers to using a red color palette or green color palette to assist the user or operator in the dark when adjusting to low light conditions. During night operation of imaging system 100A, 100B, human visual capacity to see in the dark may be impaired by the blinding effect of a bright image on a display monitor. Hence, the night mode setting changes the color palette from a standard black hot or white hot palette to a red or green color palette display. In one aspect, the red or green color palette is generally known to interfere less with human night vision capacity. In one example, for a red-green-blue (RGB) type of display, the green and blue pixels may be disabled to boost the red color for a red color palette. In another implementation, the night mode display may be combined with any other mode of operation of imaging system 100A, 100B, as described herein, and a default display mode of imaging system 100A, 100B at night may be the night mode display.

Furthermore in various implementations, certain image features may be appropriately marked (e.g., color-indicated or colorized, highlighted, or identified with other indicia), such as during the image processing (block 225) or displaying of the processed image (block 240), to aid a user to identify these features while viewing the displayed image. For example, as discussed further herein, during a man overboard mode, a suspected person (e.g., or other warm-bodied animal or object) may be indicated in the displayed image with a blue color (or other color or type of marking) relative to the black and white palette or night color palette (e.g., red palette). As another example, as discussed further herein, during a night time or daytime cruising mode and/or hazy conditions mode, potential hazards in the water may be indicated in the displayed image with a yellow color (or other color or type of marking) to aid a user viewing the display. Further details regarding image colorization may be found, for example, in U.S. Pat. No. 6,849,849, which is incorporated herein by reference in its entirety.

In various implementations, processing component 110 may switch the processing mode of a captured image in real time and change the displayed processed image from one mode, corresponding to mode modules 112A-112N, to a different mode upon receiving user input from control component 150. As such, processing component 110 may switch a current mode of display to a different mode of display for viewing the processed image by the user or operator on display component 140. This switching may be referred to as applying the image processing techniques of mode modules 112A-112N for real time applications, wherein a user or operator may change the displayed mode while viewing an image on display component 140 based on user input to control component 150.

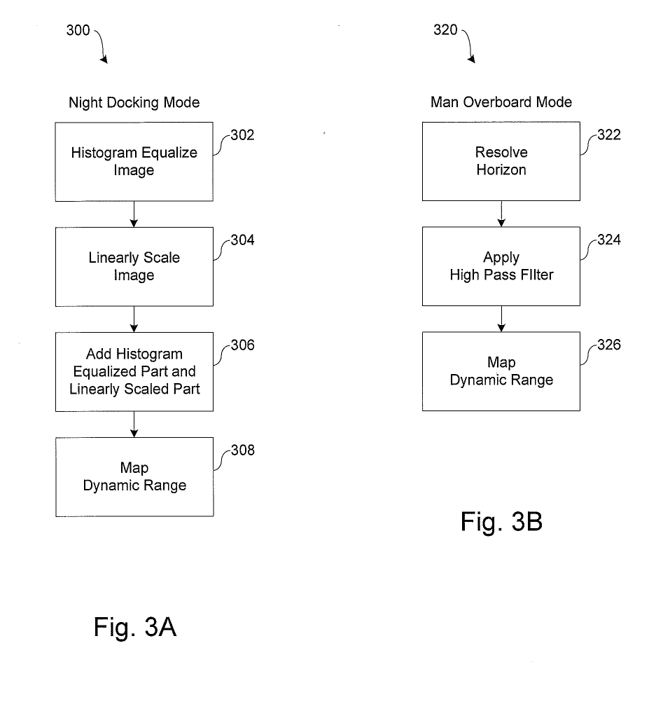

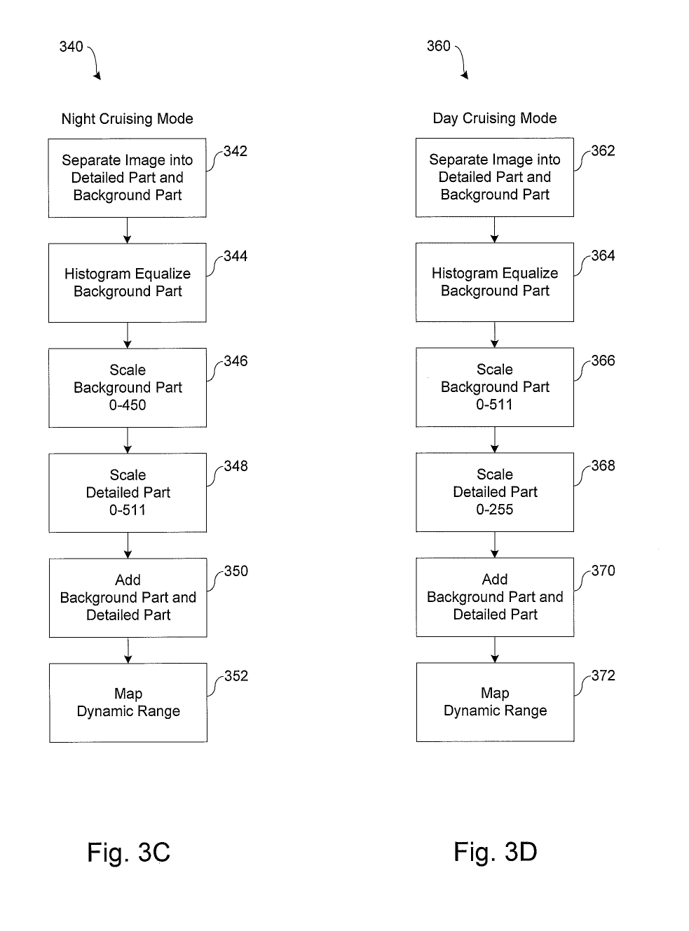

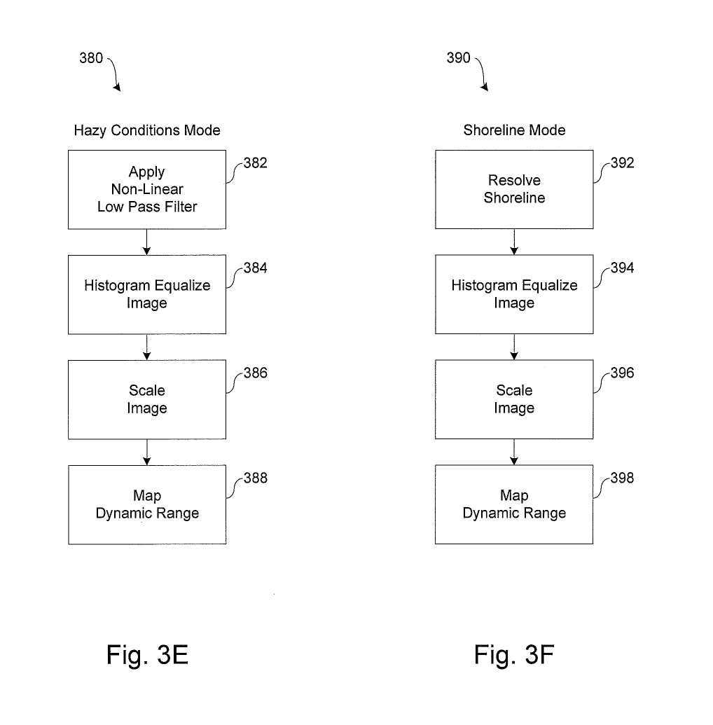

FIGS. 3A-3E show block diagrams illustrating infrared processing techniques of maritime modes in accordance with various embodiments of the present disclosure. As described herein, imaging system 100A, 100B may be adapted to switch between different modes of operation so as to improve the infrared images and information provided to a user or operator.

FIG. 3A shows one embodiment of an infrared processing technique 300 as described in reference to block 225 of FIG. 2. In one implementation, the infrared processing technique 300 comprises a night docking mode of operation for maritime applications. For example, during night docking, a watercraft or sea vessel is in the vicinity of a harbor, jetty or marina, which have proximate structures including piers, buoys, other watercraft, other structures on land. A thermal infrared imager (e.g., imaging system 100A, 100B) may be used as a navigational tool in finding a correct docking spot. The imaging system 100A, 10013 produces an infrared image that assists the user or operator in docking the watercraft. There is a high likelihood of hotspots in the image, such as dock lights, vents and running motors, which may have a minimal impact on how the scene is displayed.

Referring to FIG. 3A, the input image is histogram equalized and scaled (e.g., 0-511) to form a histogram equalized part (block 302). Next, the input image is linearly scaled (e.g., 0-128) while saturating the highest and lowest (e.g., 1%) to form a linearly scaled part (block 304). Next, the histogram-equalized part and the linearly scaled part are added together to form an output image (block 306). Next, the dynamic range of the output image is linearly mapped to fit the display component 140 (block 308). It should be appreciated that the block order in which the process 300 is executed may be executed in a different order without departing from the scope of the present disclosure.

In one embodiment, the night docking mode is intended for image settings with large amounts of thermal clutter, such as a harbor, a port, or an anchorage. The settings may allow the user to view the scene without blooming on hot objects. Hence, infrared processing technique 300 for the night docking mode is useful for situational awareness in maritime applications when, for example, docking a watercraft with low visibility.

In various implementations, during processing of an image when the night docking mode is selected, the image is histogram equalized to compress the dynamic range by removing “holes” in the histogram. The histogram may be plateau limited so that large uniform areas, such as sky or water components, are not given too much contrast. For example, approximately 20% of the dynamic range of the output image may be preserved for a straight linear mapping of the non-histogram equalized image. In the linear mapping, for example, the lowest 1% of the pixel values are mapped to zero and the highest 1% of the input pixels are mapped to a maximum value of the display range (e.g., 235). In one aspect, the final output image becomes a weighted sum of the histogram equalized and linearly (with 1% “outlier” cropping) mapped images.

FIG. 3B shows one embodiment of an infrared processing technique 320 as described in reference to block 225 of FIG. 2. In one implementation, the infrared processing technique 320 comprises a man overboard mode of operation for maritime applications. For example, in the man overboard mode, imaging system 100A, 10013 may be tuned to the specific task of finding a person in the water. The distance between the person in the water and the watercraft may not be known, and the person may be only a few pixels in diameter or significantly larger if lying close to the watercraft. In one aspect, even if a person may be close to the watercraft, the person may not have enough thermal signature to be clearly visible, and thus the man overboard display mode may target the case where the person has weak thermal contrast and is far enough away so as to not be clearly visible without the aid of imaging system 100A, 100B.

Referring to FIG. 3B, image capture component 130 (e.g., infrared camera) of imaging system 100A, 100B is positioned to resolve or identify the horizon (block 322). In one implementation, the infrared camera is moved so that the horizon is at an upper part of the field of view (FOV). In another implementation, the shoreline may also be indicated along with the horizon. Next, a high pass filter (HPF) is applied to the image to form an output image (block 324). Next, the dynamic range of the output image is linearly mapped to fit the display component 140 (block 326). It should be appreciated that the block order in which the process 320 is executed may be in an different order without departing from the scope of the present disclosure.

In one example, horizon identification may include shoreline identification, and the horizon and/or shoreline may be indicated by a line (e.g., a red line or other indicia) superimposed on a thermal image along the horizon and/or the shoreline, which may be useful for users or operators to determine position of the watercraft in relation to the shoreline. Horizon and/or shoreline identification may be accomplished by utilizing a real-time Hough transform or other equivalent type of transform applied to the image stream, wherein this image processing transform finds linear regions (e.g., lines) in an image. The real-time Hough transform may also be used to find the horizon and/or shoreline in open ocean when, for example, the contrast may be low. Under clear conditions, the horizon and/or shoreline may be easily identified. However, on a hazy day, the horizon and/or shoreline may be difficult to locate.

In general, knowing where the horizon and/or shoreline are is useful for situational awareness. As such, in various implementations, the Hough transform may be applied to any of the maritime modes of operation described herein to identify the horizon and/or shoreline in an image. For example, the shoreline identification (e.g., horizon and/or shoreline) may be included along with any of the processing modes to provide a line (e.g., any type of marker, such as a red line or other indicia) on the displayed image and/or the information may be used to position the infrared camera's field of view.

In one embodiment of the man overboard mode, signal gain may be increased to bring out minute temperature differences of the ocean, such as encountered when looking for a hypothermic body in a uniform ocean temperature that may be close to the person's body temperature. Image quality is traded for the ability to detect small temperature changes when comparing a human body to ocean temperature. Thus, infrared processing technique 320 for the man overboard mode is useful for situational awareness in maritime applications when, for example, searching for a man overboard proximate to the watercraft.

In various implementations, during processing of an image when the man overboard mode is selected, a high pass filter is applied to the image. For example, the signal from the convolution of the image by a Gaussian kernel may be subtracted. The remaining high pass information is linearly stretched to fit the display range, which may increase the contrast of any small object in the water. In one enhancement of the man overboard mode, objects in the water may be marked, and the system signals the watercraft to direct a searchlight at the object. For systems with both visible and thermal imagers, the thermal imager is displayed. For zoom or multi-FOV systems, the system is set in a wide FOV. For pan-tilt controlled systems with stored elevation settings for the horizon, the system is moved so that the horizon is visible just below the upper limit of the field of view.

In one embodiment, the man overboard mode may activate a locate procedure to identify an area of interest, zoom-in on the area of interest, and position a searchlight on the area of interest. For example, the man overboard mode may activate a locate procedure to identify a position of a object (e.g., a person) in the water, zoom-in the infrared imaging device (e.g., an infrared camera) on the identified object in the water, and then point a searchlight on the identified object in the water. In various implementations, these actions may be added to process 200 of FIG. 2 and/or process 320 of FIG. 3B and further be adapted to occur automatically so that the area of interest and/or location of the object of interest may be quickly identified and retrieved by a crew member.

FIG. 3C shows one embodiment of an infrared processing technique 340 as described in reference to block 225 of FIG. 2. In one implementation, the infrared processing technique 340 comprises a night cruising mode of operation for maritime applications. For example, during night cruising, the visible channel has limited use for other than artificially illuminated objects, such as other watercraft. The thermal infrared imager may be used to penetrate the darkness and assist in the identification of buoys, rocks, other watercraft, islands and structures on shore. The thermal infrared imager may also find semi-submerged obstacles that potentially lie directly in the course of the watercraft. In the night cruising mode, the display algorithm may be tuned to find objects in the water without distorting the scene (i.e., field of view) to the extent that it becomes useless for navigation.

In one embodiment, the night cruising mode is intended for low contrast situations encountered on an open ocean. The scene (i.e., field of view) may be filled with a uniform temperature ocean, and any navigational aids or floating debris may sharply contrast with the uniform temperature of the ocean. Therefore, infrared processing technique 340 for the night cruising mode is useful for situational awareness in, for example, open ocean.

Referring to FIG. 3C, the image is separated into a background image part and a detailed image part (block 342). Next, the background image part is histogram equalized (block 344) and scaled (e.g., 0-450) (block 346). Next, the detailed image part is scaled (e.g., 0-511) (block 348). Next, the histogram-equalized background image part and the scaled detailed image part are added together to form an output image (block 350). Next, the dynamic range of the output image is linearly mapped to fit the display component 140 (block 352). It should be appreciated that the block order in which the process 340 is executed may be executed in a different order without departing from the scope of the present disclosure.

In various implementations, during processing of an image when the night cruising mode is selected, the input image is split into detailed and background image components using a non-linear edge preserving low pass filter (LPF), such as a median filter or by anisotropic diffusion. The background image component comprises a low pass component, and the detailed image part is extracted by subtracting the background image part from the input image. To enhance the contrast of small and potentially weak objects, the detailed and background image components may be scaled so that the details are given approximately 60% of the output/display dynamic range. In one enhancement of the night cruising mode, objects in the water are tracked, and if they are on direct collision course as the current watercraft course, then they are marked in the image, and an audible and/or visual alarm may be sounded and/or displayed, respectively. In some implementations, for systems with both visible and thermal imager, the thermal imager may be displayed by default.

In one embodiment, a first part of the image signal may include a background image part comprising a low spatial frequency high amplitude portion of an image. In one example, a low pass filter (e.g., low pass filter algorithm) may be utilized to isolate the low spatial frequency high amplitude portion of the image signal (e.g., infrared image signal). In another embodiment, a second part of the image signal may include a detailed image part comprising a high spatial frequency low amplitude portion of an image. In one example, a high pass filter (e.g., high pass filter algorithm) may be utilized to isolate the high spatial frequency low amplitude portion of the image signal (e.g., infrared image signal). Alternately, the second part may be derived from the image signal and the first part of the image signal, such as by subtracting the first part from the image signal.

In general for example, the two image parts (e.g., first and second parts) of the image signal may be separately scaled before merging the two image parts to produce an output image. For example, the first or second parts may be scaled or both the first and second parts may be scaled. In one aspect, this may allow the system to output an image where fine details are visible and tunable even in a high dynamic range scene. In some instances, as an example, if an image appears less useful or degraded by some degree due to noise, then one of the parts of the image, such as the detailed part, may be suppressed rather than amplified to suppress the noise in the merged image to improve image quality.

FIG. 3D shows one embodiment of an infrared processing technique 360 as described in reference to block 225 of FIG. 2. In one implementation, the infrared processing technique 360 comprises a day cruising mode of operation for maritime applications. For example, during day cruising, the user or operator may rely on human vision for orientation immediately around the watercraft. Imaging system 100A, 100B may be used to zoom in on objects of interest, which may involve reading the names of other watercraft, and searching for buoys, structures on land, etc.

Referring to FIG. 3D, the image is separated into a background image part and a detailed image part (block 362). Next, the background image part is histogram equalized (block 364) and scaled (e.g., 0-511) (block 366). Next, the detailed image part is scaled 0-255 (block 368). Next, the histogram-equalized background image part and the scaled detailed image part are added together to form an output image (block 370). Next, the dynamic range of the output image is linearly mapped to fit the display component 140 (block 372). It should be appreciated that the block order in which the process 360 is executed may be executed in an different order without departing from the scope of the present disclosure.

In one embodiment, the day cruising mode is intended for higher contrast situations, such as when solar heating leads to greater temperature differences between unsubmerged or partially submerged objects and the ocean temperature. Hence, infrared processing technique 360 for the day cruising mode is useful for situational awareness in, for example, high contrast situations in maritime applications.

In various implementations, during processing of an image when the day cruising mode is selected, the input image is split into its detailed and background components respectively using a non-linear edge preserving low pass filter, such as a median filter or by anisotropic diffusion. For color images, this operation may be achieved on the intensity part of the image (e.g., Y in a YCrCb format). The background image part comprises the low pass component, and the detailed image part may be extracted by subtracting the background image part from the input image. To enhance the contrast of small and potentially weak objects, the detailed and background image parts may be scaled so that the details are given approximately 35% of the output/display dynamic range. For systems with both visible and thermal imagers the visible image may be displayed by default.

FIG. 3E shows one embodiment of an infrared processing technique 380 as described in reference to block 225 of FIG. 2. In one implementation, the infrared processing technique 380 comprises a hazy conditions mode of operation for maritime applications. For example, even during daytime operation, a user or operator may achieve better performance from an imager using an infrared (MWIR, LWIR) or near infrared (NIR) wave band. Depending on vapor content and particle size, a thermal infrared imager may significantly improve visibility under hazy conditions. If neither the visible nor thermal imagers penetrate the haze, imaging system 100A, 100B may be set in hazy conditions mode under which system 100A, 100B attempts to extract what little information is available from the chosen infrared sensor. Under hazy conditions, there may be little high spatial frequency information (e.g., mainly due, in one aspect, to scattering by particles). The information in the image may be obtained from the low frequency part of the image, and boosting the higher frequencies may drown the image in noise (e.g., temporal and/or fixed pattern).

Referring to FIG. 3E, a non-linear edge preserving low pass filter (LPF) is applied to the image (block 382). Next, the image is histogram equalized (block 384) and scaled (block 386) to form a histogram equalized output image. Next, the dynamic range of the output image is linearly mapped to fit the display component 140 (block 388). It should be appreciated that the block order in which the process 380 is executed may be in a different order without departing from the scope of the present disclosure.

In various implementations, during processing of an image when the hazy conditions mode is selected, a non-linear, edge preserving, low pass filter, such as median or by anisotropic diffusion is applied to the image (i.e., either from the thermal imager or the intensity component of the visible color image). In one aspect, the output from the low pass filter operation may be histogram equalized and scaled to map the dynamic range to the display and to maximize contrast of the display.

FIG. 3F shows one embodiment of an infrared processing technique 390 as described in reference to block 225 of FIG. 2. In one implementation, the infrared processing technique 390 comprises a shoreline mode of operation for maritime applications.

Referring to FIG. 3F, the shoreline may be resolved (block 392). For example as discussed previously, shoreline identification (e.g., horizon and/or shoreline) may be determined by applying an image processing transform (e.g., a Hough transform) to the image (block 392), which may be used to position the infrared camera's field of view and/or to provide a line (e.g., any type of marker, such as a red line(s) or other indicia on the displayed image. Next, the image is histogram equalized (block 394) and scaled (block 396) to form an output image. Next, the dynamic range of the output image is linearly mapped to fit the display component 140 (block 398). It should be appreciated that the block order in which the process 390 is executed may be in a different order without departing from the scope of the present disclosure.

In one implementation, the information produced by the transform (e.g., Hough transform) may be used to identify the shoreline or even the horizon as a linear region for display. The transform may be applied to the image in a path separate from the main video path (e.g., the transform when applied does not alter the image data and does not affect the later image processing operations), and the application of the transform may be used to detect linear regions, such as straight lines (e.g., of the shoreline and/or horizon). In one aspect, by assuming the shoreline and/or horizon comprises a straight line stretching the entire width of the frame, the shoreline and/or horizon may be identified as a peak in the transform and may be used to maintain the field of view in a position with reference to the shoreline and/or horizon. As such, the input image (e.g., preprocessed image) may be histogram equalized (block 394) and scaled (block 396) to generate an output image, and then the transform information (block 392) may be added to the output image to highlight the shoreline and/or horizon of the displayed image.

Moreover, in the shoreline mode of operation, the image may be dominated by sea (i.e., lower part of image) and sky (i.e., upper part of image), which may appear as two peaks in the image histogram. In one aspect, significant contrast is desired over the narrow band of shoreline, and a low number (e.g., relatively based on the number of sensor pixels and the number of bins used in the histogram) may be selected for the plateau limit for the histogram equalization. In one aspect, for example, a low plateau limit (relative) may reduce the effect of peaks in the histogram and give less contrast to sea and sky while preserving contrast for the shoreline and/or horizon regions.

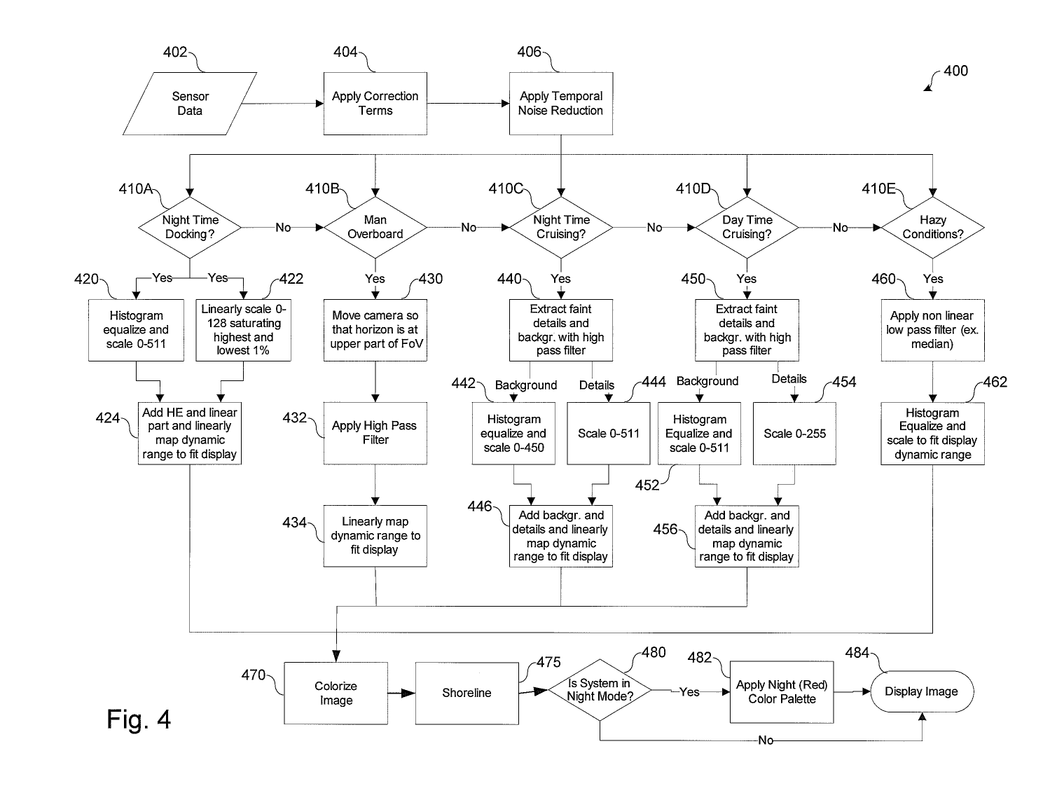

FIG. 4 shows a block diagram illustrating a method 400 of implementing maritime modes 410A-410E and infrared processing techniques related thereto, as described in reference to various embodiments of the present disclosure. In particular, a first maritime mode refers to night docking mode 410A, a second maritime mode refers to man overboard mode 410B, a third maritime mode refers to night cruising mode 410C, a fourth maritime mode refers to day cruising mode 410D, and a fifth maritime mode refers to hazy conditions mode 410E.

In one implementation, referring to FIG. 4, processing component 110 of imaging system 100A, 100B of FIGS. 1A, 1B may perform method 400 as follows. Sensor data (i.e., infrared image data) of a captured image is received or obtained (block 402). Correction terms may be applied to the received sensor data (block 404), and temporal noise reduction may be applied to the received sensor data (block 406).

Next, at least one of the selected maritime modes 410A-410E may be selected by a user or operator via control component 150 of imaging system 100A, 100B, and processing component 110 executes the corresponding processing technique associated with the selected maritime mode of operation. In one example, if night docking mode 410A is selected, then the sensor data may be histogram equalized and scaled (e.g., 0-511) (block 420), the sensor data may be linearly scaled (e.g., 0-128) saturating the highest and lowest (e.g., 1%) (block 422), and the histogram equalized sensor data is added to the linearly scaled sensor data for linearly mapping the dynamic range to display component 140 (block 424). In another example, if man overboard mode 410B is selected, then infrared capturing component 130 of imaging system 100A, 100B may be moved or positioned so that the horizon is at an upper part of the field of view (FOV) and/or directed to an area of interest, a high pass filter (HPF) is applied to the sensor data (block 432), and the dynamic range of the high pass filtered sensor data is then linearly mapped to fit display component 140 (block 434). In another example, if night cruising mode 410C is selected, the sensor data is processed to extract a faint detailed part and a background part with a high pass filter (block 440), the background part is histogram equalized and scaled (e.g., 0-450) (block 442), the detailed part is scaled (e.g., 0-511) (block 444), and the background part is added to the detailed part for linearly mapping the dynamic range to display component 140 (block 446). In another example, if day cruising mode 410D is selected, the sensor data is processed to extract a faint detailed part and a background part with a high pass filter (block 450), the background part is histogram equalized and scaled (e.g., 0-511) (block 452), the detailed part is scaled 0-255 (block 454), and the background part is added to the detailed part for linearly mapping the dynamic range to display component 140 (block 456). In still another example, if hazy condition mode 410E is selected, then a non-linear low pass filter (e.g., median) is applied to the sensor data (block 460), which is then histogram equalized and scaled for linearly mapping the dynamic range to display component 140 (block 462).

For any of the maritime modes (e.g., blocks 410A-410E), the image data for display may be marked (e.g., color coded, highlighted, or otherwise identified with indicia) to identify, for example, a suspected person in the water (e.g., for man overboard) or a hazard in the water (e.g., for night time cruising, day time cruising, or any of the other modes). For example, as discussed herein, image processing algorithms may be applied (block 470) to the image data to identify various features (e.g., objects, such as a warm-bodied person, water hazard, horizon, or shoreline) in the image data and appropriately mark these features to assist in recognition and identification by a user viewing the display. As a specific example, a suspected person in the water may be colored blue, while a water hazard (e.g., floating debris) may be colored yellow in the displayed image.

Furthermore for any of the maritime modes (e.g., blocks 410A-410E), the image data for display may be marked to identify, for example, the shoreline (e.g., shoreline and/or horizon). For example, as discussed herein, image processing algorithms may be applied (block 475) to the image data to identify the shoreline and/or horizon and appropriately mark these features to assist in recognition and identification by a user viewing the display. As a specific example, the horizon and/or shoreline may be outlined or identified with red lines on the displayed image to aid the user viewing the displayed image.

Next, after applying at least one of the infrared processing techniques for maritime modes 410A-410E, a determination is made as to whether to display the processed sensor data in night mode (i.e., apply the night color palette) (block 480), in a manner as previously described. If yes, then the night color palette is applied to the processed sensor data (block 482), and the processed sensor data is displayed in night mode (block 484). If no, then the processed sensor data is displayed in a non-night mode manner (e.g., black hot or white hot palette) (block 484). It should be appreciated that, in night mode, sensor data (i.e., image data) may be displayed in a red or green color palette to improve night vision capacity for a user or operator.

FIG. 5 shows a block diagram illustrating one embodiment of control component 150 of imaging system 100A, 100B for selecting between different maritime modes of operation, as previously described for example in reference to FIGS. 3A-4. In one embodiment, control component 150 of imaging system 100A, 100B may comprise a user input and/or interface device, such as control panel unit 500 (e.g., a wired or wireless handheld control unit) having one or more push buttons 510, 520, 530, 540, 550, 560, 570 adapted to interface with a user and receive user input control values and further adapted to generate and transmit one or more input control signals to processing component 110. In various other embodiments, control panel unit 500 may comprise a slide bar, rotatable knob to select the desired mode, keyboard, etc., without departing from the scope of the present disclosure.

In various implementations, a plurality of push buttons 510, 520, 530, 540, 550, 560, 570 of control panel unit 500 may be utilized to select between various maritime modes of operation as previously described for example in reference to FIGS. 3A-4. In various implementations, processing component 110 may be adapted to sense control input signals from control panel unit 500 and respond to any sensed control input signals received from push buttons 510, 520, 530, 540, 550, 560, 570. Processing component 110 may be further adapted to interpret the control input signals as values. In various other implementations, it should be appreciated that control panel unit 500 may be adapted to include one or more other push buttons (not shown) to provide various other control functions of imaging system 100A, 100B, such as auto-focus, menu enable and selection, field of view (FOV), brightness, contrast, display zoom, fishfinder sensitivity, radar range, radar gain, audio volume, audio track, autopilot pattern, and/or various other features. In another embodiment, control panel unit 500 may comprise a single push button, which may be used to select each of the maritime modes of operation 510, 520, 530, 540, 550, 560, 570.

In another embodiment, control panel unit 500 may be adapted to be integrated as part of display component 140 to function as both a user input device and a display device, such as, for example, a user activated touch screen device adapted to receive input signals from a user touching different parts of the display screen. As such, the GUI interface device may have one or more images of, for example, push buttons 510, 520, 530, 540, 550, 560, 570 adapted to interface with a user and receive user input control values via the touch screen of display component 140.

In one embodiment, referring to FIG. 5, a first push button 510 may be enabled to select the night docking mode of operation, a second push button 520 may be enabled to select the man overboard mode of operation, a third push button 530 may be enabled to select the night cruising mode of operation, a fourth push button 540 may be enabled to select the day cruising mode of operation, a fifth push button 550 may be enabled to select the hazy conditions mode of operation, a sixth push button 560 may be enabled to select the shoreline mode of operation, and a seventh push button 570 may be enabled to select or turn the night display mode (i.e., night color palette) off. In another embodiment, a single push button for control panel unit 500 may be used to toggle to each of the maritime modes of operation 510, 520, 530, 540, 550, 560, 570 without departing from the scope of the present disclosure.

FIG. 6 shows a block diagram illustrating an embodiment of image capture component 130 of imaging system 100A, 100B. As shown, image capture component 130 may be adapted to comprise a first camera component 132, a second camera component 134, and/or a searchlight component 136. In various implementations, each of the components 132, 134, 136 may be integrated as part of image capture component 130 or one or more of the components 132, 134, 136 may be separate from image capture component 130 without departing from the scope of the present disclosure.

In one embodiment, first camera component 132 may comprise an infrared camera component capable of capturing infrared image data of image 170. In general, an infrared camera is a device that is adapted to form an image using infrared radiation, which may be useful for rescue operations in water and/or darkness.

In one embodiment, second camera component 134 may comprise another infrared camera component or a camera capable of capturing visible spectrum images of image 170. In general, a visible-wavelength camera may be used by a crew member of watercraft 180 to view and examine the image 170. For example, in daylight, the visible-wavelength camera may assist with viewing, identifying, and locating a man overboard.

In various implementations, the camera components 132, 134 may be adapted to include a wide and/or narrow field of view (e.g., a fixed or variable field of view). For example, this feature may include a telescoping lens that narrows the field of view to focus on a particular area within the field of view.

In one embodiment, searchlight component 136 comprises a device capable of projecting a beam of light towards image 170 in the field of view. In one implementation, searchlight component 136 is adapted to focus a beam of light on a target within the field of view of at least one of camera components 132, 134 so as to identify and locate, for example, a position of a man overboard, which would allow a crew member of watercraft 180 to have improved visibility of the man overboard in darkness.

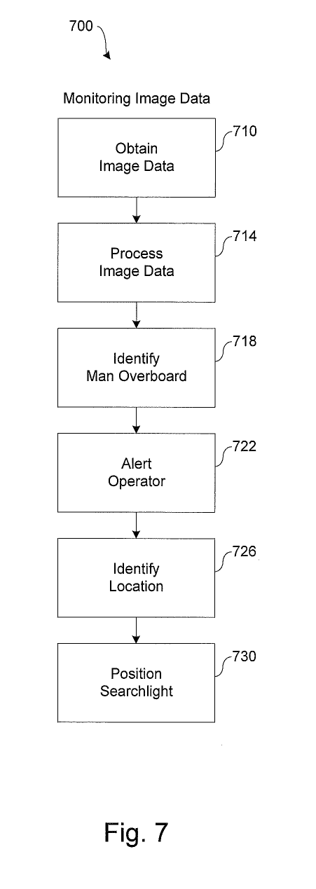

FIG. 7 shows a block diagram illustrating an embodiment of a method 700 for monitoring image data of imaging system 100A, 100B. In one implementation, method 700 is performed by processing component 110 of imaging system 100A, 100B. As shown in FIG. 7, image data is obtained (block 710). In various implementations, the image data may be obtained directly from the image capture component 130 or from storage in memory component 120.

Next, the obtained image data may be processed (block 714). In one implementation, the obtained image data may be processed using the man overboard mode of operation 320 of FIG. 3B to collect image data to detect an object, such as a person, falling into or in the water proximate to watercraft 180.

Next, a man overboard (e.g., person) may be identified from the processed image data (block 718). In one implementation, the object (e.g., a person) may be separated from the water based on the temperature difference therebetween. For example, when a person having a body temperature of approximately 98 degrees falls into the water having a water temperature of approximately 60-70 degrees or less, the difference between the temperatures is viewable with an infrared image, and therefore, the person may be quickly identified and located in the water.

In an example embodiment, various types of conventional image processing software (e.g., a software package by ObjectVideo located in Reston, Va.) may be run by processing component 110 to perform image analysis to monitor the image data and detect a man overboard condition. In an example embodiment, features in such conventional software may support the use of threshold conditions or object discrimination, for example, to distinguish non-living objects, such as a deck chair or other inanimate objects, from a person.

Programming the software package with threshold factors such as temperature, shape, size, aspect ratio, velocity, or other factors may assist a software package in discriminating images of non-living and/or non-human objects from images of humans. Thus, threshold conditions for use as desired in a given application may provide that a bird flying through a camera's field of view, for example, may be ignored, as would a falling deck chair or cup of hot coffee thrown overboard.

When a man overboard condition is suspected or determined, an operator (e.g., crew member) may be alerted or notified (block 722) so that a rescue action may be initiated. In various implementations, this alert or notification may comprise an audio signal and/or visual signal, such as an alarm, a warning light, a siren, a bell, a buzzer, etc.

Next, the specific location of the man overboard may be identified based on the image data (block 726). In one implementation, identifying the location of the person may include narrowing the field of view of the image capture component 130. For example, a lens of the infrared camera may telescope to a position to zoom-in on the object or person in the water or zoom-in on at least the proximate location of the person in the water or another narrower field of view image capture component 130 may be directed to the proximate location of the person in the water. Furthermore, a searchlight (e.g., searchlight component 136 of the image capture component 130) may be directed to the proximate location of the person in the water (block 730) to assist with the retrieval and rescue of the person overboard.

When a man overboard condition is detected, for example in accordance with an embodiment, the time and/or location of the event may be recorded along with the image data (e.g., as part of block 722 or 726), such as to aid in the search and rescue operation and/or to provide information for later analysis of the suspected man overboard event. Alternatively, the time and/or location may be regularly recorded with the image data. For example, processing component 110 (FIGS. 1A, 1B) may include a location determination function (e.g., a global positioning system (GPS) receiver or by other conventional location determination techniques) to receive precise location and/or time information, which may be stored (e.g., in memory component 120) along with the image data. The image data along with the location information and/or time information may then be used, for example, to allow a search and rescue crew to leave the ship (e.g., cruise ship) and backtrack in a smaller vessel or helicopter to the exact location of the man overboard condition in a prompt fashion as a large ship generally would not be able to quickly stop and return to the location of the man overboard event.

As noted above, varying aspects of the present disclosure may be carried out utilizing different components, such as different control components, processing components, display components, and/or image capture components. For example, referring now to FIGS. 8A and 8B, block diagrams illustrate embodiments of control components 800A and 800B, respectively, for selecting between different modes of operation and/or display in accordance with embodiments of the present disclosure and as further described herein. In one implementation, control components 800A, 800B are part of an imaging system such as imaging systems 100A, 100B described above (e.g. control component 150 of FIGS. 1A, 1B) and may be portable (e.g., handheld), mountable, or built into a portion of the vehicle (e.g., a steering wheel of a watercraft) for ease of use by a user to select a mode of operation (e.g., a map mode, a sonar mode, a fishfinder mode, a radar mode, an autopilot pattern mode, an entertainment mode, and/or a maritime mode) and perform an adjustment or selection within the mode of operation (e.g., increasing or decreasing some function of map display zoom, sonar display zoom, fishfinder sonar sensitivity, radar range, radar gain, audio volume, audio track, or autopilot pattern, or selecting a particular maritime mode as described above for example with respect to FIGS. 3A-4). For example for one or more embodiments, control components 800A or 800B may be used to select and adjust a map mode (e.g., zoom in/out of displayed map or reposition portion of map displayed), a sonar mode (e.g., zoom in/out of displayed image), a fishfinder mode (e.g., increase/decrease sensitivity), a radar range mode (e.g., increase/decrease range, sensitivity and/or gain), an entertainment mode (e.g., increase/decrease volume and/or previous/next track), an autopilot pattern mode (e.g., increase/decrease such as tighten/loosen pattern), and/or a maritime mode (e.g., selection of desired mode and/or functionality within mode).

Control components 800A, 800B (also referred to herein as steering wheel control components as an example implementation) may communicate with processing component 110 and/or display component 140 wirelessly (e.g., via Bluetooth or other wireless standard) or via a wired connection. Various wireless communication protocols and standards are applicable and may be used without departing from the scope of the present disclosure. In one embodiment, steering wheel control components 800A, 800B may further include mounts allowing the steering wheel control components to be mountable to a watercraft steering wheel. Mounts may include clips, bolts, straps, buttons, tabs, and/or other mounting structures in order to mount control components 800A, 800B onto a steering wheel. In other embodiments, steering wheel control components 800A, 800B may be built into or otherwise integrated with a watercraft steering wheel or other portion of the vehicle for ease of use by a user of control components 800A, 800B.

In one embodiment, control components 800A and 800B may comprise a user input and/or interface device (e.g., as discussed herein in reference to control component 150 and/or similarly as described in reference to FIG. 5) having a mode button 802 adapted to interface with a user and receive user input control values and further adapted to generate and transmit one or more input control signals to processing component 110 via a wire or wirelessly. The single mode button 802 (e.g., a mode selector, such as any type of user input selector interface) is adapted to cycle through or toggle to the different modes of operation (e.g., a map mode, a sonar mode, a fishfinder mode, a radar mode, an autopilot pattern mode, an entertainment mode, and a maritime mode) to send a first user input signal to processing component 110. In other embodiments, control components 800A, 800B may include a plurality of mode buttons with each mode button enabled to select a particular mode.

Control component 800A further includes an increase/decrease actuator 804 (e.g., increase/decrease selector), which in one case can be two push buttons for indicating an increase function and a decrease function, as shown by an increase button 804a and a decrease button 804b in control component 800B. Actuator 804 is adapted to interface with a user and receive user input control values and further adapted to generate and transmit one or more input control signals to processing component 110 (via a wire or wirelessly) to make an adjustment or selection within the selected mode of operation (e.g., increasing or decreasing one of map display zoom, sonar display zoom, fishfinder sonar sensitivity, radar range, radar gain, audio volume, audio track, or autopilot pattern, or selecting a particular maritime mode as described above for example with respect to FIGS. 3A-4). Accordingly, increase/decrease actuator 804 may send a second user input signal to processing component 110 to make an adjustment or selection within the selected mode of operation or first user input signal. In other embodiments, the increase/decrease actuator 804 along with mode button 802 may be comprised of a toggle switch, a rotatable knob, a rotatable wheel, a slide bar, a touch screen, an actuator, or other types of user input devices without departing from the scope of the present disclosure.

In various implementations, processing component 110 may be adapted to sense control input signals from control components 800A, 800B and respond to any sensed control input signals (e.g., first and second user input signals) received from mode button 802 and increase/decrease actuator 804. Processing component 110 may be further adapted to interpret the control input signals as values. Processing component 110 may further include a location determination function (e.g., a global positioning system (GPS) receiver or other conventional location determination techniques) to receive precise location and/or time information for navigation purposes in the various modes of operation. In various other implementations, it should be appreciated that control components 800A, 800B may be adapted to include one or more other push buttons or actuators (not shown) to provide various other control functions of imaging system 100A, 100B, such as auto-focus, menu enable and selection, field of view (FOV), brightness, contrast, and/or various other features.

In another embodiment, control component 800A, 800B may be adapted to be integrated as part of display component 140, the combination of which is then integrated or mounted to the watercraft steering wheel, to function as both a user input device and a display device, such as, for example, a user activated touch screen device adapted to receive input signals from a user touching different parts of the display screen. As such, the GUI interface device may have one or more images of, for example, mode button 802 and increase/decrease actuator 804 adapted to interface with a user and receive user input control values via the touch screen of display component 140.

In one embodiment, image capture components 130 may include radar, sonar, and/or fishfinder sensors which are available from Raymarine® Inc. of Merrimack, N.H. In another embodiment, display component 140 may include multifunction navigation displays also available from Raymarine® Inc.

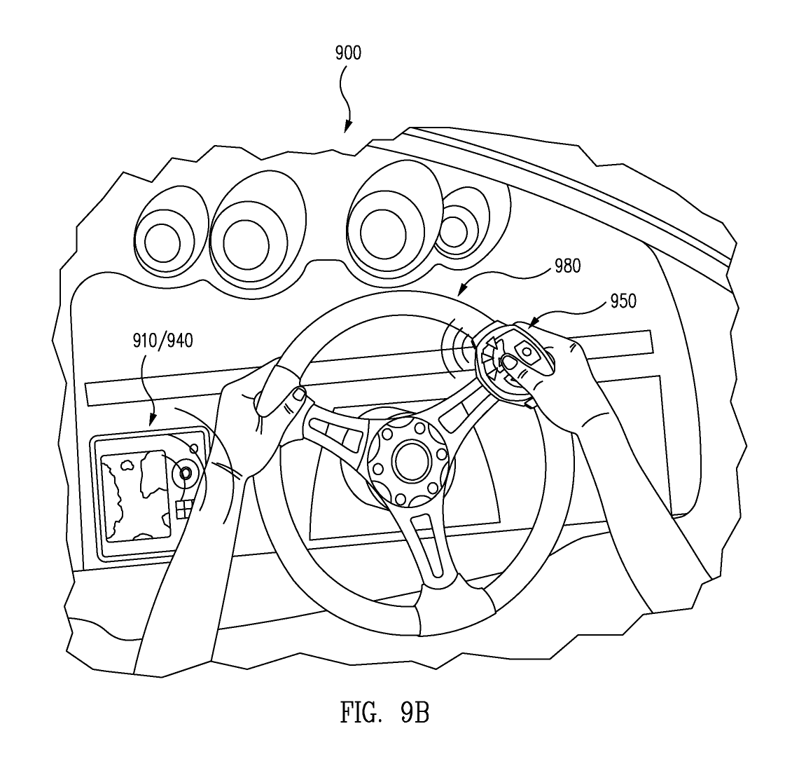

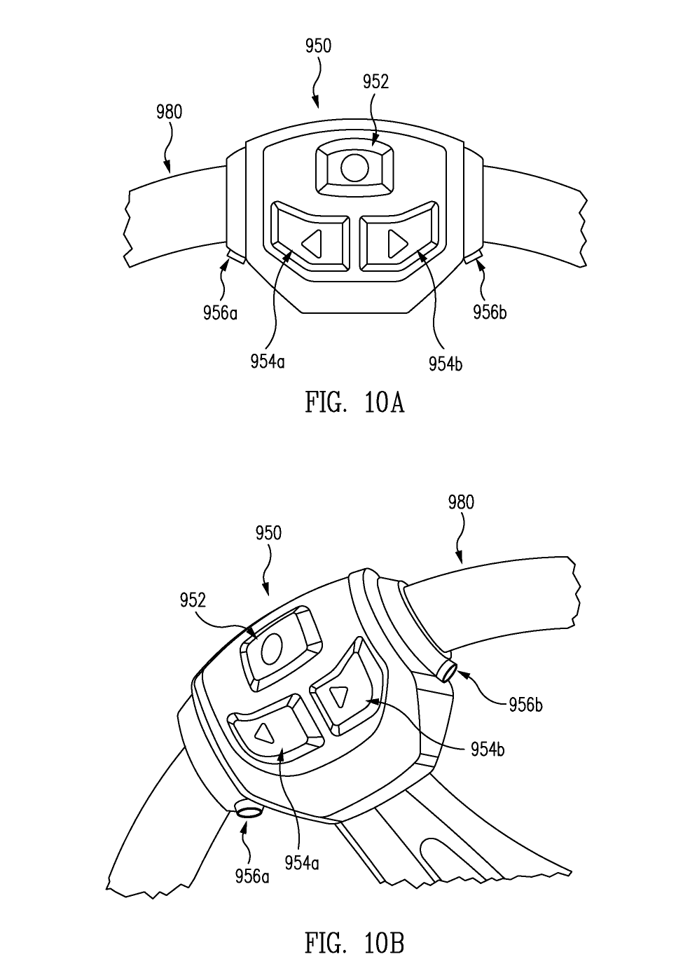

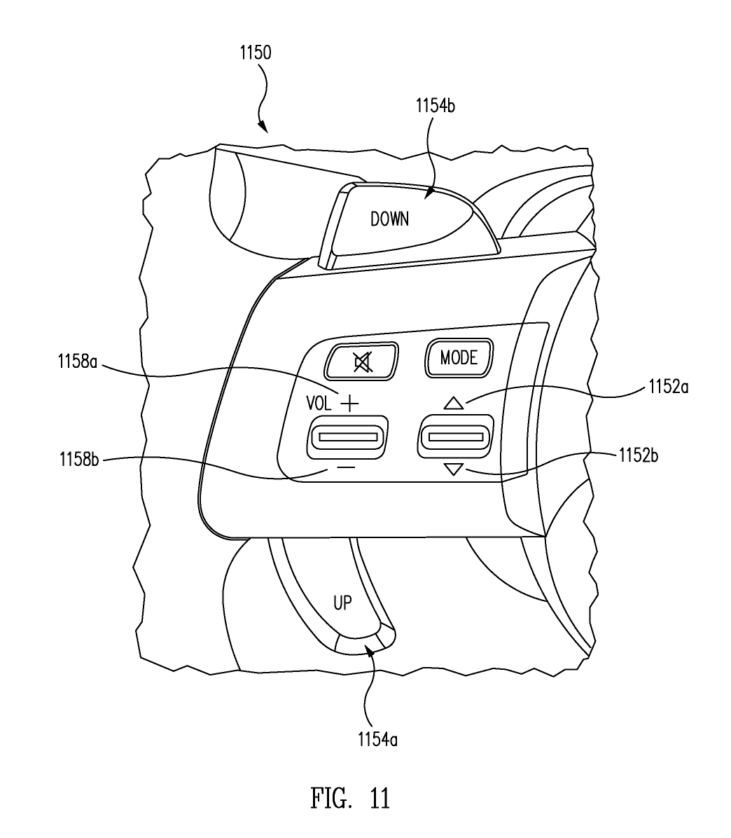

Referring now to FIGS. 9A-9B and 10A-10B, a control system 900 includes a steering wheel control component 950, a maritime steering wheel 980 of a watercraft, and a processing component 910/display component 940 (e.g., a multifunction GPS navigation display) in accordance with one embodiment of the present disclosure. FIG. 9A illustrates control component 950 mounted to steering wheel 980, and FIG. 9B illustrates a user wirelessly sending a user input signal through a button of control component 950 to a processing component 910/display component 940. FIGS. 10A and 10B illustrate different close-up views of the control component 950 illustrated in FIGS. 9A and 9B in accordance with embodiments of the present disclosure.

Steering wheel control component 950 (e.g., an example implementation of control component 150 of FIG. 1A) may include similar structures and functionality as that described above with respect to control components 500 and 800A, 800B, and are fully applicable in this embodiment although the same descriptions may not be repeated here. According to one aspect, control component 950 includes a mode button 952, an increase button 954a, a decrease button 954b, and mounting tabs 956a, 956b. Mode button 952 is adapted to interface with a user and receive user input control values and is further adapted to generate and wirelessly transmit one or more input control signals to processing component 9101 display component 940. The single mode button 952 is adapted to cycle through or toggle to the different modes of operation (e.g., a map mode, a sonar mode, a fishfinder mode, a radar mode, an autopilot pattern mode, an entertainment mode, and a maritime mode) to send a first user input signal to processing component 910/display component 940.

Increase and decrease buttons 954a, 954b are each adapted to interface with a user and receive user input control values and are further adapted to generate and wirelessly transmit one or more input control signals to processing component 910 to make an adjustment or selection within the selected mode of operation (e.g., increasing or decreasing one of map display zoom, sonar display zoom, fishfinder sonar sensitivity, radar range, radar gain, audio volume, audio track, or autopilot pattern, or selecting a particular maritime mode as described above for example with respect to FIGS. 3A-4). Accordingly, increase and decrease buttons 954a, 954b may send a second user input signal to processing component 910/display component 940 to make an adjustment or selection within the selected mode of operation or first user input signal.

FIG. 11 illustrates another steering wheel control component 1150 for selecting between different modes of operation and/or display in accordance with another embodiment of the present disclosure (e.g., an example implementation of control component 150 of FIG. 1A). In this embodiment, control component 1150 includes up and down mode buttons 1152a, 1152b, up and down flipper actuators 1154a, 1154b, and increase and decrease volume buttons 1158a, 1158b. Up and down mode buttons 1152a, 1152b are adapted to interface with a user and receive user input control values and is further adapted to generate and wirelessly transmit one or more input control signals to processing component 910/display component 940. The up and down mode buttons may be similarly used as the single mode button to cycle to the different modes of operation (e.g., a map mode, a sonar mode, a fishfinder mode, a radar mode, an autopilot pattern mode, an entertainment mode, and/or a maritime mode) to send a first user input signal to processing component 910/display component 940.

Up and down flipper actuators 1154a, 1154b are each adapted to interface with a user and receive user input control values and are further adapted to generate and wirelessly transmit one or more input control signals to processing component 910 to make an adjustment or selection within the selected mode of operation (e.g., increasing or decreasing one of map display zoom, sonar display zoom, fishfinder sonar sensitivity, radar range, radar gain, audio volume, audio track, or autopilot pattern, and/or selecting a particular maritime mode as described above for example with respect to FIGS. 3A-4). Accordingly, up and down flipper actuators 1154a, 1154b may send a second user input signal to processing component 910/display component 940 to make an adjustment or selection within the selected mode of operation or first user input signal. Increase and decrease volume buttons 1158, 1158b may be used to control audio volume from the display component or operably connected speakers.

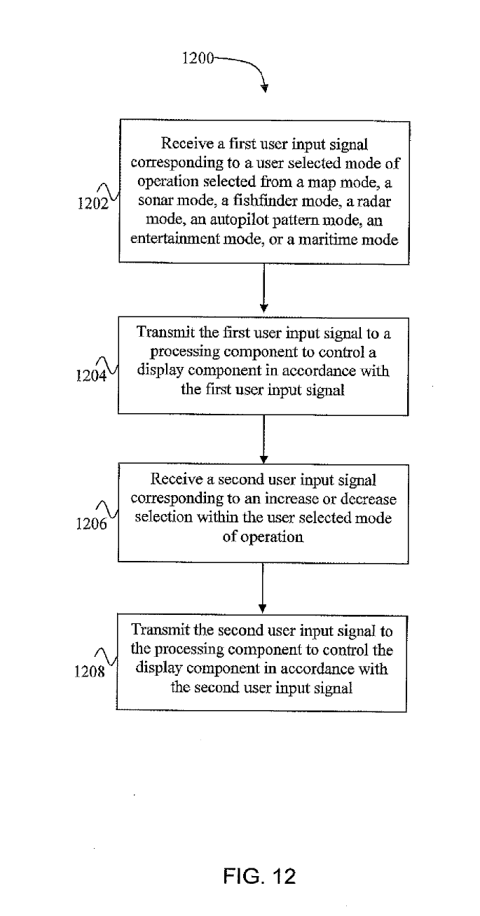

Referring now to FIG. 12, a block diagram illustrates a control method 1200 in accordance with an embodiment of the present disclosure. Method 1200 begins at block 1202 where a first user input signal is received, for example by a mode button of a steering wheel control component. The first user input signal corresponds to a user selected mode of operation from a plurality of selectable modes of operation including a map mode, a sonar mode, a fishfinder mode, a radar mode, an autopilot pattern mode, an entertainment mode, and/or a maritime mode.

At block 1204, the first user input signal is transmitted (via wire or wirelessly) to a processing component to control a display component in accordance with the first user input signal. The processing component and display component may be housed together in a multifunction navigation display in one example. The display component may display a particular image depending upon the mode of operation selected in accordance with the first user input signal.

At block 1206, a second user input signal is received, for example by an increase/decrease actuator of a steering wheel control component. The second user input signal corresponds to an adjustment (e.g., an increase or decrease adjustment) or selection within the user selected mode of operation, such as increasing or decreasing one of a map display zoom, a sonar display zoom, a fishfinder sonar sensitivity, a radar range, a radar gain, an audio volume, an audio track, or an autopilot pattern, or selecting a particular maritime mode as described above for example with respect to FIGS. 3A-4.

At block 1208, the second user input signal is transmitted (via wire or wirelessly) to the processing component to control the display component in accordance with the second user input signal. Accordingly, the display can be adjusted within the mode of operation or selections can be made within the mode of operation, such as a particular maritime mode within the plurality of maritime modes.

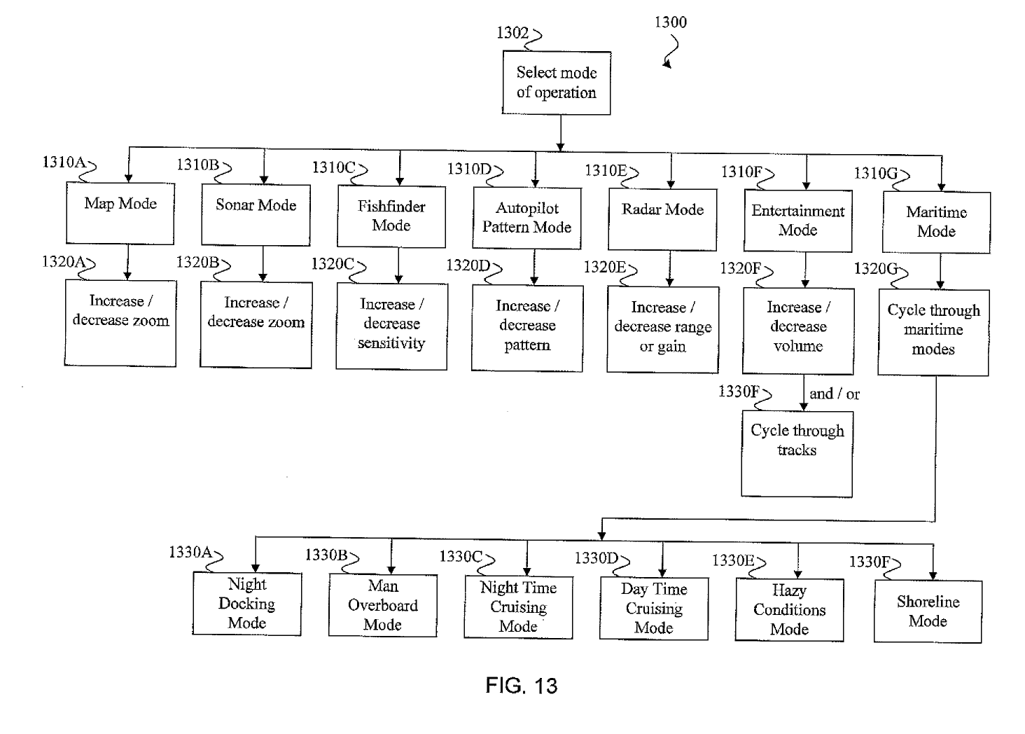

Referring now to FIG. 13, a block diagram illustrates an overview of first and second user input selections in a display control method 1300 in accordance with various embodiments of the present disclosure. Method 1300 includes a first user input selecting a mode of operation at block 1302, the modes of operation including a map mode 1310A, a sonar mode 1310B, a fishfinder mode 1310C, an autopilot pattern mode 1310D, a radar mode 1310E, an entertainment mode 1310F, and a maritime mode 1310G.

Map mode 1310A is used for navigation purposes and may utilize a GPS receiver or other conventional location determination techniques to receive precise location and/or time information for maritime navigation and provides a map image on the display component. Sonar mode 1310B may be used with a sonar image capture component to provide a sonar image on the display component. Fishfinder mode 1310C may be used with a sonar image capture component to provide a sonar image on the display component. Autopilot pattern mode 1310D may also utilize a GPS receiver or other conventional location determination techniques to program autopilot maritime navigation and provide an autopilot pattern on the display component. Radar mode 1310E may be used with a radar image capture component to provide a radar image on the display component. Entertainment mode 130F may be used in conjunction with an audio or other entertainment system to provide a video or audio through the display component or other apparatus operably coupled to the display component. Maritime mode 1310G may be used with an infrared image capture component to provide an infrared image on the display component as described above for example with respect to FIGS. 3A-4.

Within each mode of operation is a second user input adjustment or selection. Within map mode 1310A, a user may provide a second user input 1320A selecting to increase or decrease a particular area on the display or otherwise zooming in or zooming out on a particular point on a map on the display component. Within sonar mode 1310B, a user may provide a second user input 1320B selecting to increase or decrease a particular area on the display or otherwise zooming in or zooming out on a particular point on a sonar image on the display component. Within fishfinder mode 1310C, a user may provide a second user input 1320C selecting to increase or decrease sensitivity of the sonar image capture component to adjust the sonar image for clearer detection of underwater objects. Within autopilot pattern mode 1310D, a user may provide a second user input 1320D selecting to loosen or tighten an autopilot pattern. Within radar mode 1310E, a user may provide a second user input 1320E selecting to increase or decrease a range or gain of the radar signal. Within entertainment mode 1310F, a user may provide a second user input 1320F and/or 1330F selecting to increase or decrease an audio volume and/or selecting to cycle through different files or tracks, such as different multimedia files or audio tracks. Within maritime mode 1310G, a user may provide a second user input 1320G selecting a particular maritime mode, such as a night docking mode 1330A, a man overboard mode 1330B, a night time cruising mode 1330C, a day time cruising mode 1330D, a hazy conditions mode 1330E, or a shoreline mode 1330F, as described above for example with respect to FIGS. 3A-4.

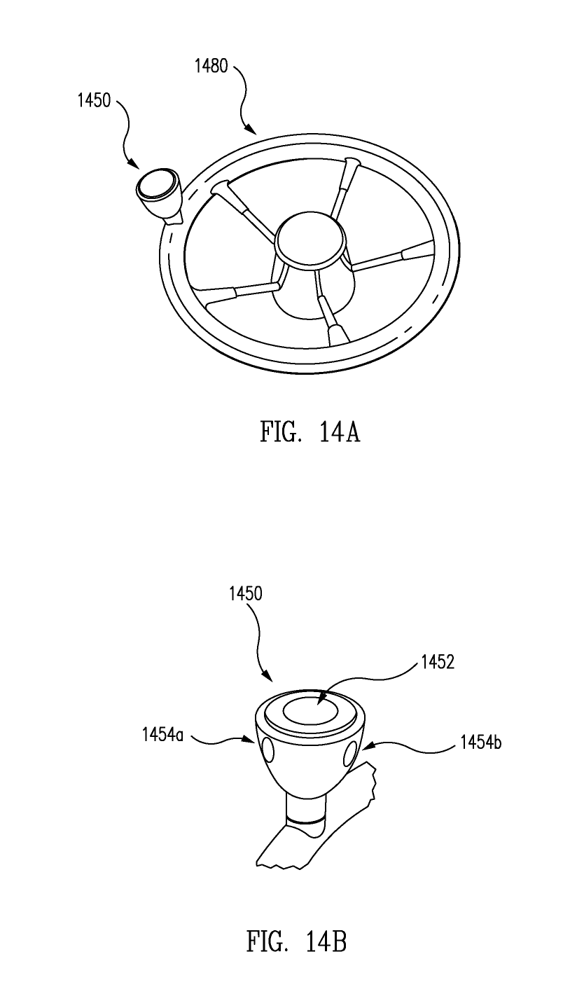

FIGS. 14A and 14B illustrate another steering wheel control component 1450 for selecting between different modes of operation and/or display in accordance with another embodiment of the present disclosure (e.g., an example implementation of control component 150 of FIG. 1A). As noted above in other embodiments, control component 1450 may be built into a maritime steering wheel 1480 of a watercraft, or control component 1450 may be a separate component that is mountable and operably couplable (e.g., mechanically and/or electrically couplable) to maritime steering wheel 1480. In one embodiment, mounting features, to mount control component 1450 onto a steering wheel such as steering wheel 1480, may include clips, bolts, straps, buttons, tabs, and/or other mounting structures. In this embodiment, control component 1450 has a form factor of a knob or other shaped protrusion from steering wheel 1480 (e.g., a knob protruding to form a handle for a user), which would allow control component 1450 to be used by a user to easily and quickly rotate steering wheel 1480 (e.g. steering wheel of a sailboat), as would be understood by one skilled in the art.

In one embodiment, control component 1450 includes a central mode button 1452 positioned on a top surface (e.g., of the knob) and increase and decrease buttons 1454a, 1454b positioned on side surfaces (e.g., of the knob). Mode button 1452 is adapted to interface with a user and receive user input control values and is further adapted to generate and wirelessly transmit one or more input control signals to processing component 910/display component 940. The mode button 1452 may be used as a single mode button to cycle through the different modes of operation (e.g., a map mode, a sonar mode, a fishfinder mode, a radar mode, an autopilot pattern mode, an entertainment mode, and/or a maritime mode) to send a first user input signal to processing component 910/display component 940.

Increase and decrease buttons 1454a, 1454b are each adapted to interface with a user and receive user input control values and are further adapted to generate and wirelessly transmit one or more input control signals to processing component 910 to make an adjustment or selection within the selected mode of operation (e.g., increasing or decreasing one of map display zoom, sonar display zoom, fishfinder sonar sensitivity, radar range, radar gain, audio volume, audio track, or autopilot pattern, and/or selecting a particular maritime mode as described above for example with respect to FIGS. 3A-4). Accordingly, increase and decrease buttons 1454a, 1454b may be used to send a second user input signal to processing component 910/display component 940 to make an adjustment or selection within the selected mode of operation or first user input signal. Other selection/adjustment buttons may also be positioned on control component 1450 in accordance with one or more embodiments. Accordingly, steering wheel control component 1450 may provide a form factor to be used by a user to grip and steer the watercraft (e.g., a knob or other protruding form factor) and further may provide accessible buttons (e.g., mode button 1452, increase/decrease buttons 1454a, 1454b) to receive user input control signals, as described herein.

In accordance with one or more embodiments, the processing component is able to receive and process first and second user input signals in real time, where multiple first user input signals may be sent, received, and processed as a user cycles through the plurality of modes of operation, and where multiple second user input signals may be sent, received, and processed as a user makes multiple successive adjustments to an image or cycles through different selections, such as through multiple maritime modes.

Where applicable, various embodiments of the invention may be implemented using hardware, software, or various combinations of hardware and software. Where applicable, various hardware components and/or software components set forth herein may be combined into composite components comprising software, hardware, and/or both without departing from the scope and functionality of the present disclosure. Where applicable, various hardware components and/or software components set forth herein may be separated into subcomponents having software, hardware, and/or both without departing from the scope and functionality of the present disclosure. Where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, ordering of various steps described herein may be changed, combined into composite steps, and/or separated into sub-steps to provide features described herein.

In various embodiments, software for mode modules 112A-112N may be embedded (i.e., hard-coded) in processing component 110 or stored on memory component 120 for access and execution by processing component 110. As previously described, the code (i.e., software and/or hardware) for mode modules 112A-112N define, in one embodiment, preset display functions that allow processing component 110 to switch between the one or more processing techniques, as described for example in reference to FIGS. 3A-4, for displaying captured and/or processed infrared or other types of images on display component 140.

Embodiments described above illustrate but do not limit the disclosure. It should also be understood that numerous modifications and variations are possible in accordance with the principles of the present disclosure. For example, although particular modes of operation have been disclosed in the embodiments above, other modes of operation and adjustments/selections within those other modes of operation may be applicable and used in the apparatus and methods disclosed above. Accordingly, the scope of the disclosure is defined only by the following claims.

What is claimed is:

1. A control component adapted to be used with a watercraft having at least one image capture component to capture images, a memory component adapted to store the captured images, a processing component adapted to process the captured images according to a plurality of modes of operation to provide processed images, and a display component adapted to display the processed images, the control component comprising:
a mounting feature adapted to mount the control component to a steering wheel of the watercraft;
a mode selector adapted to receive a user's input to select from the plurality of modes of operation to provide a first user input signal, wherein the control component is configured to transmit the first user input signal to the processing component, and wherein the modes of operation for selection comprise a map mode, a radar mode, and an autopilot pattern mode; and
an increase/decrease actuator adapted to receive a user's input, to adjust a feature of the processed image to display for the selected mode of operation, to provide a second user input signal, wherein the control component is configured to transmit the second user input signal to the processing component.

2. The control component of claim 1, wherein the modes of operation comprise a fishfinder mode, a sonar mode, an entertainment mode, and a maritime mode.

3. The control component of claim 2, wherein the increase/decrease actuator increases or decreases an amount of zoom displayed for the map mode or sonar mode selected, increases or decreases a sensitivity for the fishfinder mode, increases or decreases an amount of range and/or gain for the radar mode, and tightens or loosens a pattern for the autopilot pattern mode.

4. The control component of claim 2, wherein the increase/decrease actuator is adapted to cycle through a plurality of maritime modes if the maritime mode is selected, and wherein the second user input signal corresponds to one of the plurality of maritime modes selected.

5. The control component of claim 4, wherein the plurality of maritime modes includes a night cruising mode, a day cruising mode, a man overboard mode, a night docking mode, a hazy conditions mode, and a shoreline mode.

6. The control component of claim 1, wherein the mounting feature includes one of straps, tabs, and/or buttons, and wherein the increase/decrease actuator includes a positive button and a negative button, an up button and a down button, a toggle switch, a knob, or a slide bar.

7. The control component of claim 1, wherein the mode selector and the increase/decrease actuator are positioned on a protrusion from the steering wheel, and wherein the protrusion is configured to be held by a user to aid in rotating the steering wheel of the watercraft.

8. A watercraft, comprising:
at least one image capture component coupled to the watercraft to capture images;
a memory component adapted to store the captured images;
a processing component adapted to process the captured images according to a plurality of modes of operation to provide processed images;
a display component adapted to display the processed images; and
a control component configured to communicate with the processing component and/or the display component, the control component comprising:
a mode selector adapted to receive a user's input to select from the plurality of modes of operation to provide a first user input signal, wherein the control component is configured to communicate the first user input signal to the processing component and/or the display component, and wherein the modes of operation for selection comprise a map mode and a radar mode; and
an increase/decrease actuator adapted to receive a user's input to provide a second user input signal to adjust a feature of the processed image to display for the selected mode of operation, wherein the control component is configured to transmit the second user input signal to the processing component and/or the display component.

9. The watercraft of claim 8, wherein the increase/decrease actuator includes a positive button and a negative button, an up button and a down button, a toggle switch, a knob, or a slide bar, and wherein the control component is mounted to a steering wheel of the watercraft.

10. The watercraft of claim 8, wherein the modes of operation comprise a fishfinder mode, a sonar mode, an entertainment mode, an autopilot pattern mode, and a maritime mode.

11. The watercraft of claim 10, wherein the increase/decrease actuator increases or decreases an amount of zoom displayed for the map mode or sonar mode selected, increases or decreases a sensitivity for the fishfinder mode, increases or decreases an amount of range and/or gain for the radar mode, and tightens or loosens a pattern for the autopilot pattern mode.

12. The watercraft of claim 11, wherein the plurality of maritime modes includes a night cruising mode, a day cruising mode, a man overboard mode, a night docking mode, a hazy conditions mode, and a shoreline mode, and wherein the increase/decrease actuator is adapted to cycle through to select one of the plurality of maritime modes.

13. The watercraft of claim 10, wherein the processing component is further adapted to receive the first and second user input signals and process captured images according to the first and second user input signals, and wherein the at least one image capture component comprises an infrared camera, a radar, and a sonar.

14. The watercraft of claim 8, wherein the processing component is further adapted to colorize the image.

15. The watercraft of claim 8, wherein the display component is adapted to display the processed image in a red color palette or a green color palette.

16. The watercraft of claim 8, further comprising a sensing component adapted to provide environmental information to the processing component.

17. The watercraft of claim 8, further comprising a steering wheel of the watercraft, and wherein the control component has a form factor of a knob protruding from the steering wheel of the watercraft, and wherein the knob is configured to be held by a user to aid in rotating the steering wheel of the watercraft.

18. A method, comprising:
receiving a first user input signal corresponding to a user selected mode of operation from a plurality of selectable modes of operation including a map mode, a sonar mode, a fishfinder mode, a radar mode, an autopilot pattern mode, an entertainment mode, and a maritime mode;
transmitting the first user input signal to a processing component to control a display component in accordance with the first user input signal;
receiving a second user input signal corresponding to an increase or decrease selection for a function of the display component corresponding to the user selected mode of operation; and
transmitting the second user input signal to the processing component to control the display component in accordance with the second user input signal.

19. The method of claim 18, wherein the second user input signal corresponds to increasing or decreasing an amount of zoom displayed for the map mode or sonar mode selected, increasing or decreasing a sensitivity for the fishfinder mode, increasing or decreasing an amount of range and/or gain for the radar mode, and tightening or loosening a pattern for the autopilot pattern mode.

20. The method of claim 18, wherein the second user input signal corresponds to selecting one of a plurality of maritime modes including a night cruising mode, a day cruising mode, a man overboard mode, a night docking mode, a hazy conditions mode, and a shoreline mode.

21. The method of claim 18, wherein the transmitting comprises a wireless transmission.

22. The method of claim 18, further comprising:
cycling through the plurality of selectable modes of operation via a mode selector; and
cycling through a plurality of maritime modes via an increase/decrease actuator in an event that the maritime mode is selected.
